(19) United States
(12) Patent Application Publication
(10) Pub. No.: US 2026/0250096 A1
(43) Pub. Date: Aug. 27, 2026

(54) MEDIUM PROCESSING APPARATUS AND IMAGE FORMING SYSTEM INCORPORATING SAME

(71) Applicant: Keita SAKAKIBARA, Aichi (JP)

(72) Inventor: Keita SAKAKIBARA, Aichi (JP)

(73) Assignee: ETRIA CO., LTD., Yokohama (JP)

(21) Appl. No.: 19/538,097

(22) Filed: Feb. 12, 2026

(30) Foreign Application Priority Data
Feb. 27, 2025 (JP) 2025-030425

(51) Int. Cl. B65H 37/04; G03G 15/00

(52) U.S. Cl. CPC B65H 37/04; G03G 15/6544; B65H 2301/5142; B65H 2301/51616; B65H 2301/5162; B65H 2515/40; B65H 2515/805; B65H 2515/83; B65H 2801/06; B65H 2801/27

(57) ABSTRACT

A medium processing apparatus includes a liquid applier, a liquid detector, circuitry, and a crimp binder. The liquid applier applies liquid to a media bundle including a medium. The liquid detector detects a liquid application amount of the liquid applied to the medium by the liquid applier. The circuitry is to specify the liquid application amount to be applied to the medium by the liquid applier based on amount information including the liquid application amount detected by the liquid detector, environmental information of an operating environment of the liquid detector, and past information of the liquid application amount, and cause the liquid applier to apply the liquid to the media bundle based on the liquid application amount specified. The crimp binder crimps and binds the media bundle applied with the liquid to perform a crimp binding operation.

### CROSS-REFERENCE TO RELATED APPLICATION

This patent application is based on and claims priority pursuant to 35 U.S.C. § 119(a) to Japanese Patent Application No. 2025-030425, filed on Feb. 27, 2025, in the Japan Patent Office, the entire disclosure of which is hereby incorporated by reference herein.

### BACKGROUND

### Technical Field

Embodiments of the present disclosure relate to a medium processing apparatus and an image forming system incorporating the medium processing apparatus.

### Related Art

For example, a post-processing apparatus is disclosed as an apparatus in the related art including a mechanism that applies liquid to a sheet bundle or sheets of a sheet bundle prior to crimp binding of the sheet bundle.

However, the above-described post-processing apparatus in the art, for example, has a problem in that any liquid application is not performed in accordance with the sheet characteristics, and the binding force of the sheet bundle cannot be appropriately obtained.

### SUMMARY

Embodiments of the present disclosure described herein provide a novel medium processing apparatus includes a liquid applier, a liquid detector, circuitry, and a crimp binder. The liquid applier applies liquid to a media bundle including a medium. The liquid detector detects a liquid application amount of the liquid applied to the medium by the liquid applier. The circuitry is to specify the liquid application amount to be applied to the medium by the liquid applier based on amount information including the liquid application amount detected by the liquid detector, environmental information of an operating environment of the liquid detector, and past information of the liquid application amount, and cause the liquid applier to apply the liquid to the media bundle based on the liquid application amount specified. The crimp binder crimps and binds the media bundle applied with the liquid to perform a crimp binding operation.

Further, embodiments of the present disclosure described herein provide an image forming system including an image forming apparatus, and a medium processing apparatus. The image forming apparatus forms an image on a medium of a media bundle. The image forming apparatus includes circuitry to specify a liquid application amount based on environmental information of an operating environment, and past information of the liquid application amount. The medium processing apparatus performs a process on the medium. The medium processing apparatus includes a liquid applier, a liquid detector, circuitry, and a crimp binder. The liquid applier applies liquid to the media bundle including the medium. The liquid detector detects a liquid application amount of the liquid applied to the medium by the liquid applier. The circuitry is to cause the liquid applier to apply the liquid to the media bundle based on amount information detected by the liquid detector and the liquid application amount specified. The crimp binder crimps and binds the media bundle applied with the liquid to perform a crimp binding operation.

Further, embodiments of the present disclosure described herein provide an image forming system including an information processing apparatus, an image forming apparatus, and a medium processing apparatus. The information processing apparatus specified a liquid application amount based on environmental information of an operating environment, and past information of the liquid application amount. The image forming apparatus is communicable with the information processing apparatus to form an image on a medium of a media bundle. The image forming apparatus includes an information communicator to transmit the environmental information to the information processing apparatus, and receive information of the liquid application amount specified by the information processing apparatus. The medium processing apparatus performs a process on the medium. The medium processing apparatus includes a liquid applier, a liquid detector, circuitry, and a crimp binder. The liquid applier applies liquid to the media bundle including the medium. The liquid detector detects a liquid application amount of the liquid applied to the medium by the liquid applier. The circuitry is to cause the liquid applier to apply the liquid to the media bundle based on amount information detected by the liquid detector, and the liquid application amount received via the information communicator of the image forming apparatus. The crimp binder crimps and binds the media bundle applied with the liquid to perform a crimp binding operation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system, according to an embodiment of the present disclosure;

FIG. 2 is a diagram illustrating the configuration of a medium processing apparatus;

FIG. 3 is a diagram illustrating a schematic configuration of a stapleless stapler;

FIG. 4A including FIG. 4A(1), 4A(2), 4A(3), 4A(4), 4A(5) and 4A(6) is a diagram illustrating steps of a crimp binding operation by a stapleless stapler;

FIG. 4B including FIG. 4B(7), 4B(8), 4B(9), 4B(10), 4B(11) and 4B(12) is a diagram illustrating steps of a crimp binding operation by a stapleless stapler;

FIG. 5 is a flowchart of a process of specifying a liquid application amount;

FIG. 6 is a diagram illustrating a data table of temperature and humidity and a liquid application amount;

FIG. 7 is a diagram illustrating a table including a dataset added to the data table of FIG. 6;

FIG. 8 is a diagram illustrating a data table of correction values of a liquid application amount;

FIG. 9 is a diagram illustrating a table including a dataset added to the data table of FIG. 7;

FIG. 10 is a diagram illustrating an overview of a generation step and utilization of a trained model;

FIG. 11 is a flowchart of a process of specifying a liquid application amount using machine learning;

FIG. 12 is a diagram illustrating a data table prepared as training data;

FIG. 13 is a flowchart of a process of correcting a defect of the stapleless stapler;

FIG. 14 is a diagram illustrating a data table of temperature and humidity and a liquid application amount with respect to a first sheet of each sheet bundle;

FIG. 15 is a diagram illustrating a table including a dataset added to the data table of FIG. 14;

FIG. 16 is a flowchart of a process corresponding to a change in the state of a sheet;

FIG. 17 is a diagram illustrating a data table of deviations of the number of a sheet bundle and a target moisture content;

FIG. 18 is a diagram illustrating a data table of temperature and humidity, liquid application amount, and the number of sheets (in the case of outer sheets);

FIG. 19 is a diagram illustrating a data table of temperature and humidity, liquid application amount, and the number of sheets (in the case of inner sheets);

FIG. 20 is a diagram illustrating a data table of temperature and humidity, liquid application amount, and sheet type;

FIG. 21 is a diagram illustrating a data table of temperature and humidity, liquid application amount, and sheet thickness;

FIG. 22 is a diagram illustrating a data table of temperature and humidity, liquid application amount, and water type;

FIG. 23 is a diagram illustrating a data table of temperature and humidity, liquid application amount, and fixing temperature;

FIG. 24 is a diagram illustrating a data table related to temperature and humidity, liquid application amount, the number of sheets, and sheet type;

FIG. 25 is a diagram illustrating a configuration of an image forming system including a trained model;

FIG. 26 is a diagram illustrating a configuration of an image forming system including a trained model in a cloud system;

FIG. 27 is a diagram illustrating a hardware configuration of an image forming apparatus;

FIG. 28 is a diagram illustrating a hardware configuration of a controller and a server included in a medium processing apparatus; and

FIG. 29 is a diagram illustrating a functional configuration of the image forming system of FIG. 26.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

Referring to the drawings, a description is given below of embodiments of the present disclosure.

### Schematic Configuration of Image Forming System 1

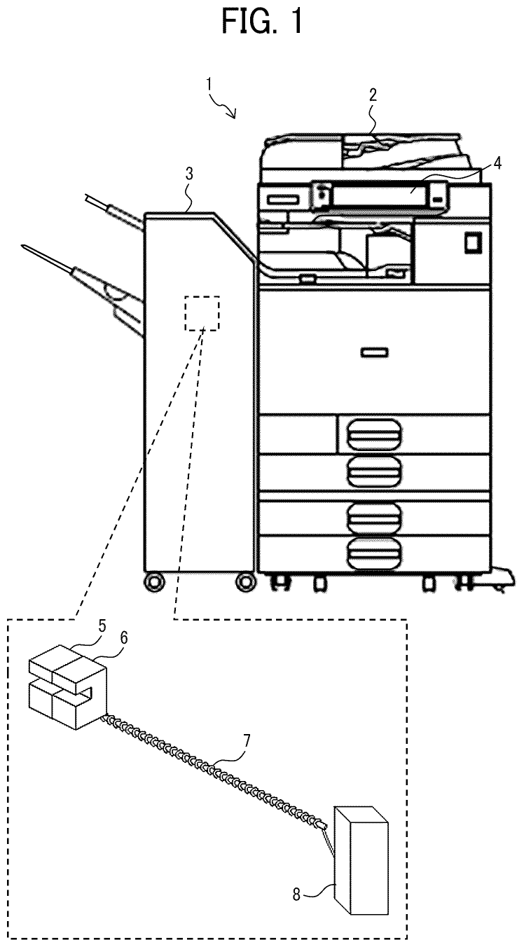

FIG. 1 is a diagram illustrating an overall configuration of an image forming system 1, according to embodiments of the present disclosure.

The image forming system 1 includes an image forming apparatus 2 and a medium processing apparatus 3. The image forming apparatus 2 is disposed upstream from the medium processing apparatus 3. The medium processing apparatus 3 is attachable to the side face of the image forming apparatus 2. A medium on which an image has been formed is conveyed from a sheet ejection port formed in the side face of the image forming apparatus 2 to the medium processing apparatus 3. The medium conveyed to the medium processing apparatus 3 is subjected to a given process in the medium processing apparatus 3. The medium used in the image forming system 1 according to the present embodiment may be any medium that can be applied to processes (e.g., a conveyance process, a liquid application process) described below. Further, a medium that can be applied to the present embodiment may be a sheet medium. A sheet of paper is described as an example of a medium below.

The image forming apparatus 2 includes, for example, an operation unit 4 to check the status of the image forming apparatus 2 and to set the image formation mode. The medium processing apparatus 3 includes at least one type of stapler (a stapleless stapler 5 is illustrated in FIG. 1), a water application unit 6, a main tank 8, and a coil tube 7. The water application unit 6 is disposed in the vicinity of the at least one type of stapler. The main tank 8 is to supply water. The coil tube 7 is to convey water (liquid) from the main tank 8 to the water application unit 6. The tube for water supply may not be in a coil shape.

### Configuration of Medium Processing Apparatus 3

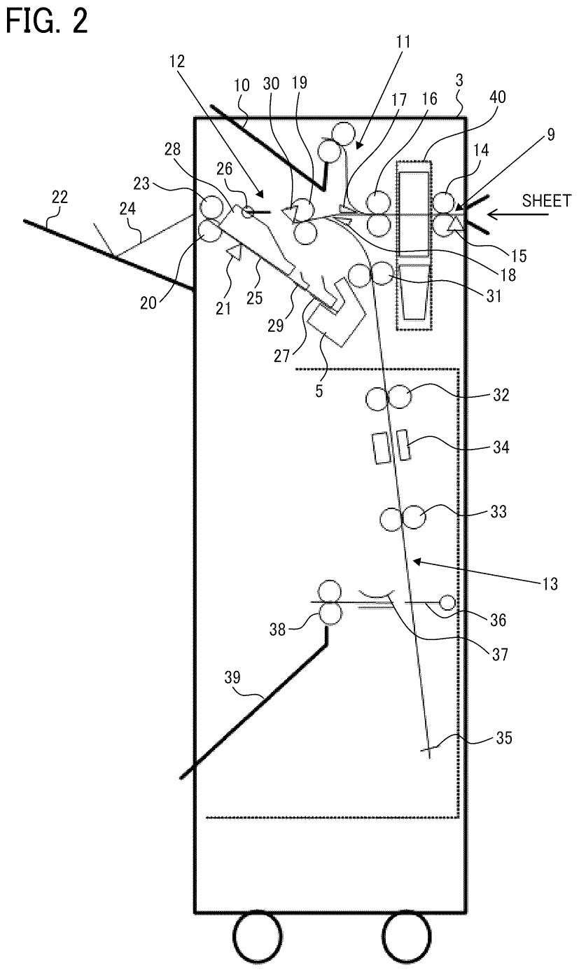

FIG. 2 is a diagram illustrating an example of the configuration of the medium processing apparatus 3.

A description is given below of the configuration of each part.

### Receiving Sheets

The sheet includes an inlet path 9 that receives a sheet on which image formation has been performed is ejected from the image forming apparatus 2, and three paths that are branched from the inlet path 9. The three paths include an upper conveyance path 11, a straight conveyance path 12, and a lower conveyance path 13. The upper conveyance path 11 is a path toward a proof tray 10. The straight conveyance path 12 is a path where a shift process, an edge binding process, and a dual stapling process are performed. The lower conveyance path 13 is a path where a saddle stitching and folding process is performed. The inlet path 9 is provided with an entrance roller 14 and an entrance sensor 15. The entrance sensor 15 detects that a sheet is conveyed into the medium processing apparatus 3. A horizontal conveyance roller 16 is disposed downstream from the entrance roller 14 in the conveyance direction. As the directions of a separation finger 17 and a separation finger 18 disposed at the terminal end of the inlet path 9 are changed to different directions, the travel direction (conveyance direction) of the sheet is sorted to any of the upper conveyance path 11, the straight conveyance path 12, and the lower conveyance path 13.

### Ejection to Proof Tray

The upper conveyance path 11 is a path to convey the sheet to the proof tray 10. The sheet whose travel direction is changed from the inlet path 9 by the separation finger 17 is ejected to the proof tray 10.

### Ejection to Shift Tray

The straight conveyance path 12 is provided with an intermediate conveyance roller 19. The sheet is conveyed to the straight conveyance path 12 via the intermediate conveyance roller 19. The straight conveyance path 12 is further provided with a sheet ejection roller 20 and a sheet ejection sensor 21. In the shift/sort mode, as the intermediate conveyance roller 19 including a shifting mechanism is moved by a drive unit by a certain amount in a direction orthogonal to the conveyance direction during the conveyance, the sheet is also shifted by a certain amount. By so doing, the sheet is ejected to a sheet ejection tray 22 by a sheet ejection roller 20, and the sheets are subsequently stacked.

The sheet ejection port to the sheet ejection tray 22 has a configuration in which the sheet ejection roller 20 and a driven roller 23 are disposed facing each other in pair so that a sheet or a sheet bundle is nipped by the sheet ejection roller 20 and the driven roller 23 and is ejected. The driven roller 23 is movable toward and away from the sheet ejection roller 20 and is in contact with the sheet ejection roller 20. More specifically, a sheet ejection guide plate including the driven roller 23 performs the contact and separation operation with respect to the sheet ejection roller 20. In the contact and separation operation, the sheet ejection guide plate selectively switches between a closed state in which a sheet or a sheet bundle is nipped to be ejected and an open state in which the sheet or the sheet bundle is not nipped. After the shift operation of the sheet (or the sheet bundle) is completed, the sheet (or the sheet bundle) is nipped and ejected.

### Vertical Movement of Shift Tray

A feeler 24 is provided in the vicinity of the upper part of the sheet ejection port, and is rotatably located at a position near the center of the stacked sheets, and the leading end of the feeler 24 is in contact with the upper face of the sheet (or the sheet bundle). An upper face detection sensor is disposed near the root of the feeler 24 to detect the height of the leading end of the feeler 24, so as to detect the height of the upper face of the stacked sheets. As the height of sheets increases due to an increase of the number of sheets accumulated on the sheet ejection tray 22, the upper face detection sensor turns on. Then the controller causes a drive unit that moves the sheet ejection tray 22 in the vertical direction to lower the sheet ejection tray 22. When the sheet ejection tray 22 is lowered and the upper face detection sensor is turned off, the controller stops the sheet ejection tray 22 from lowering. As this operation is repeated, the sheet ejection tray 22 reaches the given height of tray full. Then, the controller sends a stop signal from the medium processing apparatus 3 to the image forming apparatus 2, so as to stop the image forming operation in the image forming system 1.

### Binding Process and Ejection of Bound Sheets

The straight conveyance path 12 is provided with a staple tray 25. A tapping roller, which is one of alignment members, performs a pendulum motion to contact the sheet, guides the sheet to or further upstream from the staple tray 25, and then causes the trailing end of the sheet to contact a reference fence 27 by a return roller 26 that is the other alignment member. By so doing, the position of the sheet in the conveyance direction is aligned. Further, a jogger fence 28 is disposed on the staple tray 25. The jogger fence 28 moves in a direction orthogonal to the drawing sheet to align the position in the width direction of the sheets ejected onto the staple tray 25. By performing these two operations, the sheets ejected to the staple tray 25 are aligned and stacked. After the binding process by the stapleless stapler 5 or the staple stapler arranged in parallel, the ejection process is performed by causing the sheet bundle in the conveyance direction by a release finger 29, and the sheet bundle is nipped by the sheet ejection roller 20 and the driven roller 23 during the ejection process to align the sheet bundle to be ejected onto the sheet ejection tray 22.

### Saddle Stitching and Folding Process

Before conveying a sheet to the lower conveyance path 13, the sheet firstly passes the straight conveyance path 12, and the trailing end of the sheet detected by a sheet leading end detection sensor 30 passes the branching point of the lower conveyance path 13. Only after the trailing end of the sheet has passed the branching point of the lower conveyance path 13, the direction of the separation finger 18 is switched to the lower conveyance path 13. After the direction of the separation finger 18 is switched, the intermediate conveyance roller 19 is rotated in the reverse direction to switch back the sheet, so that the sheet is conveyed to the lower conveyance path 13. The lower conveyance path 13 is further provided with saddle stitch sheet conveyance rollers 31, 32 and 33, and a saddle stitch stapler 34. When performing saddle stitching, the binding operation is performed at the center of the sheet that is conveyed to the saddle stitching position, and the sheet is conveyed by the saddle stitch sheet conveyance rollers 32 and 33 to a sheet folding stopper 35 disposed in the sheet folding portion. Subsequently, the saddle stitching operation is performed on the sheet by a sheet folding blade 36 and a sheet folding plate 37, and the sheet is then ejected by a saddle stitch sheet ejection roller 38 to a saddle stitch tray 39.

### Punching Process

The punching unit 40 disposed downstream from the entrance roller 14 of the inlet path 9 includes a registration detector and a punching processing unit. The punching processing unit performs a punching operation at an appropriate position in consideration of a registration misalignment detected by the registration detector. When performing the punching operation, the operation is performed at an appropriate position or appropriate positions of the sheet that is received by the punching unit 40. The above-described punching unit and a saddle stitching and folding processing unit are detachably attachable to the medium processing apparatus, so that a medium processing apparatus can be provided according to the needs of the user.

### Stapleless Stapling and Cramp Binding Process

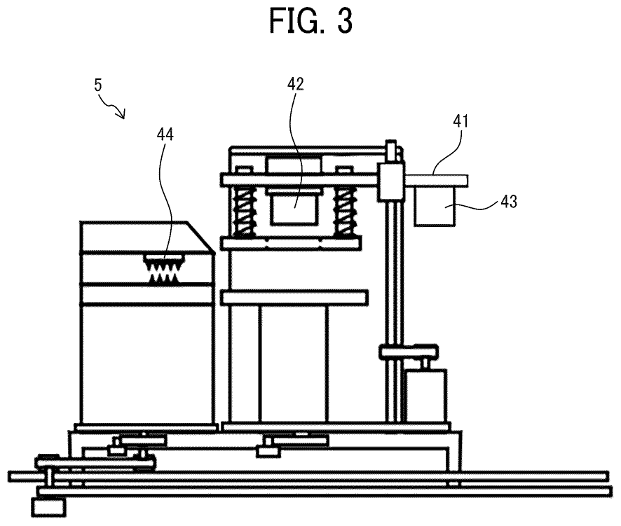

A detailed description is given of the configuration of the stapleless stapler 5, with reference to FIG. 3.

FIG. 3 is a diagram illustrating the schematic configuration of a stapleless stapler.

The stapleless stapler 5 includes a liquid application assembly 41, a liquid application member 42 as a liquid applier, a moisture content detection sensor 43 as a liquid application amount detector, and a binder 44 as a crimp binder. The liquid application assembly 41 can be driven up and down in the vertical direction via a drive source such as a motor. Due to such configuration, the liquid application member 42 can be pressed against the sheet, and liquid can be applied to the sheet. Further, as the moisture content detection sensor 43 is pressed against a sheet in the portion (also referred to as a liquid application object portion) where the liquid is applied by the liquid application member 42, the liquid application amount absorbed by the sheet can be detected.

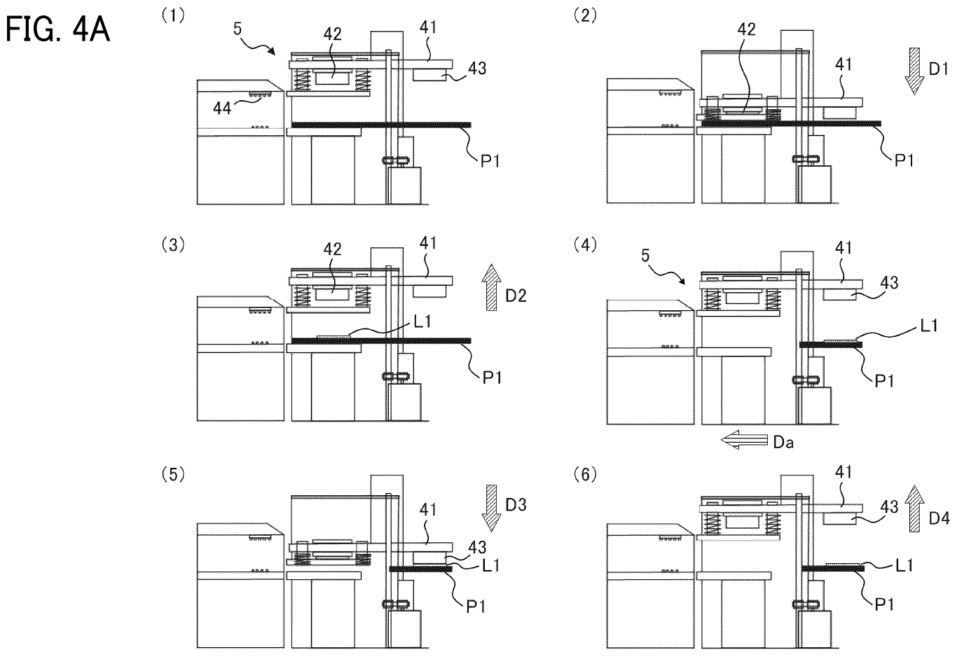

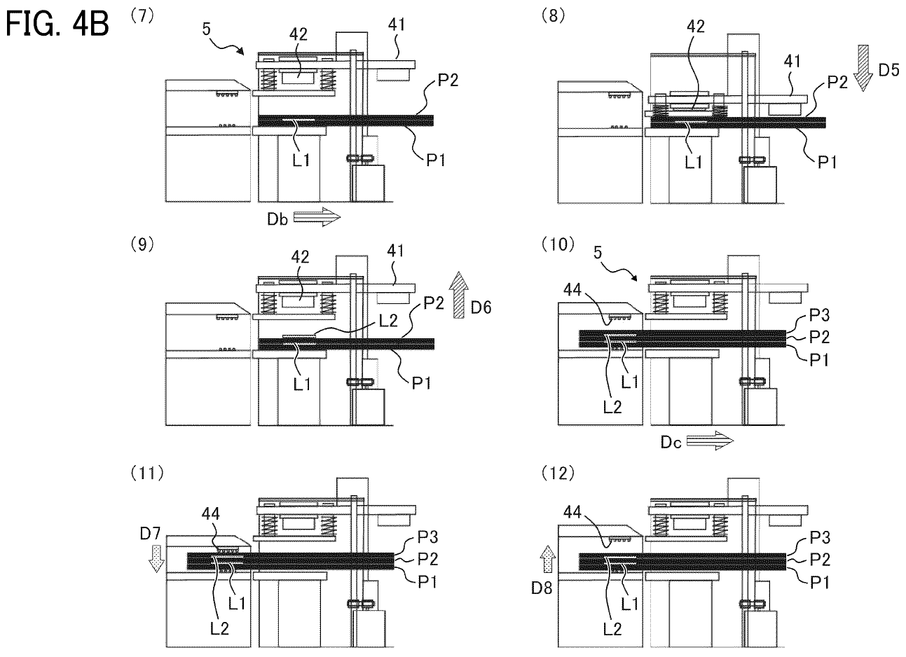

A description is given below of the operations from when the stapleless stapler 5 receives the sheets to when the crimp binding operation is completed, with reference to FIG. 4A (including FIG. 4A(1), 4A(2), 4A(3), 4A(4), 4A(5) and 4A(6)) and 4B (including FIG. 4B(7), 4B(8), 4B(9), 4B(10), 4B(11) and 4B(12)).

FIG. 4A including FIG. 4A(1), 4A(2), 4A(3), 4A(4), 4A(5) and 4A(6) is a diagram illustrating steps of the crimp binding operation by the stapleless stapler 5.

FIG. 4B including FIG. 4B(7), 4B(8), 4B(9), 4B(10), 4B(11) and 4B(12) is a diagram illustrating steps of the crimp binding operation by the stapleless stapler 5.

In the crimp binding operation, as illustrated in 4A(1), the stapleless stapler 5 receives a sheet P1 conveyed from the image forming apparatus 2 to the medium processing apparatus 3. Subsequently, as illustrated in 4A(2), the liquid application assembly 41 is moved in a direction indicated by arrow D1 via a drive source such as a motor. Then, the liquid application assembly 41 is moved in a direction approaching the sheet P1. As a result, the liquid application member 42 to which water has been supplied is pressed against the sheet P1, and liquid L1 is applied to the sheet P1, as illustrated in FIG. 4A(3). After the liquid is applied, the liquid application assembly 41 is moved in a direction indicated by arrow D2 illustrated in FIG. 4A(3) via the drive source such as a motor. Then, the liquid application assembly 41 is moved in a direction away from the sheet P1.

Subsequently, in order to detect the application amount (i.e., moisture content in the present embodiment) of the liquid L1 that is applied to the sheet P1 liquid P1 applied to the sheet L1, the stapleless stapler 5 is moved in the direction indicated by arrow Da illustrated in FIG. 4A(4), with respect to the sheet P1 so that the moisture content detection sensor 43 faces the upper side of the liquid application object portion (liquid L1). By so doing, the state of FIG. 4A(4) is obtained. Then, the liquid application assembly 41 is moved in the direction indicated by arrow D3 illustrated in FIG. 4A(5) via the drive source such as a motor. Then, the liquid application assembly 41 is moved in the direction away from the sheet P1. Accordingly, the moisture content detection sensor 43 detects the moisture content of the liquid application object portion (liquid L1). After the moisture content is detected, the liquid application assembly 41 is moved in a direction indicated by arrow D4 illustrated in FIG. 4A(6) via the drive source such as a motor. Then, the liquid application assembly 41 is moved in the direction away from the sheet P1.

Subsequently, in order to apply liquid to a second sheet P2 that is received and placed on the sheet P1, the stapleless stapler 5 is moved in the direction indicated by arrow Db illustrated in FIG. 4B(7). By so doing, the state of FIG. 4B(7) is obtained. Then, the liquid application assembly 41 is moved in the direction indicated by arrow D5 illustrated in FIG. 4B(8) via the drive source such as a motor. Then, the liquid application assembly 41 is moved in the direction approaching the sheet P2. As a result, the liquid application member 42 is pressed against the sheet P2, and liquid L2 is applied to the sheet P2, as illustrated in FIG. 4B(9). After the liquid is applied, the liquid application assembly 41 is moved in a direction indicated by arrow D6 illustrated in FIG. 4B(9) via the drive source such as a motor. Then, the liquid application assembly 41 is moved in a direction away from the sheet P2. As described above, the operations illustrated in FIG. 4B(8) and 4B(9) are repeated for liquid application to the third and subsequent sheets.

When the liquid application to the target sheets (sheets P1 and P2 in the present embodiment) is completed, in order to perform the crimp binding, the stapleless stapler 5 is moved in the direction indicated by arrow Dc illustrated in FIG. 4B(10) to the sheets P1 and P2 and a sheet P3, such that the binder 44 faces the upper side of the liquid application object portions (liquid L1 and liquid L2). By so doing, the state illustrated in FIG. 4B(10) is obtained. Then, the binding teeth of the binder 44 are moved in the direction indicated by arrow D7 illustrated in FIG. 4B(11) via the drive source such as a motor. Then, the binding teeth of the binder 44 are moved in the direction approaching the sheets P1, P2 and P3 to crimp the liquid application object portions (liquid L1 and liquid L2) and bind the sheets P1, P2 and P3. After the crimp binding is completed, the binding teeth of the binder 44 is moved in a direction indicated by arrow D8 illustrated in FIG. 4B(12) via the drive source such as a motor. Then, the binding teeth of the binder 44 are moved in a direction away from the sheets P1, P2 and P3. The crimp binding is performed by the above-described steps or procedures. Further, in order to obtain the binding force in the crimp binding operation, the sheets need to absorb a given amount of water. In a case where the liquid is absorbed more than the given amount of water absorption, the sheet is torn in the process of crimp binding operation illustrated in FIG. 4B(11). On the other hand, in a case where the amount of water absorption is less than the given amount, the sheets are immediately separated from each other, and the binding force is not likely to be secured.

However, the amount of water absorption of the sheet varies depending on various factors such as the operating environment (temperature and humidity) of the customer, the type and thickness of sheet to be used, the year of manufacture of the sheet, the manufacturing lot of the sheet, the storage environment of the sheet, or the type of liquid to be used for liquid application. For this reason, the pressing amount of the liquid application member 42 to the sheet at the time of liquid application according to these factors is to be achieved. In addition, the liquid application amount that optimizes the time to press the liquid application member 42 against the sheet P and to obtain the binding force is also to be achieved.

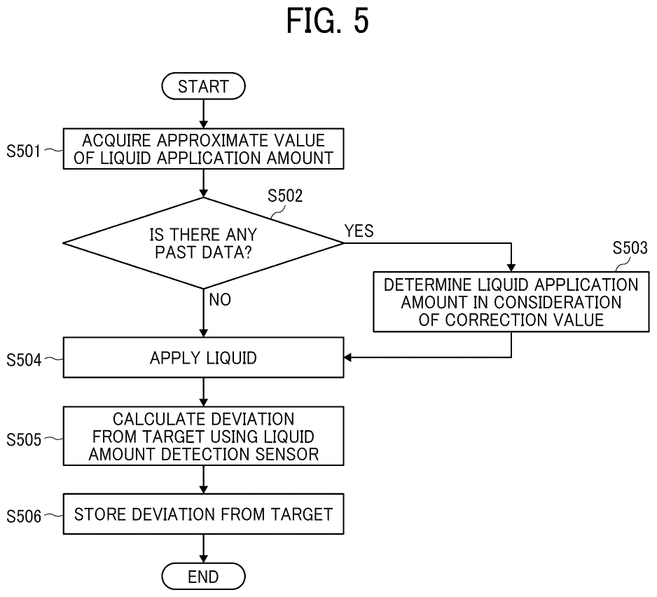

For this reason, in the present disclosure, the liquid application amount to obtain the binding force in the crimp binding is specified by the flow as illustrated in the flowchart of FIG. 5.

FIG. 5 is a flowchart of the process of specifying the liquid application amount.

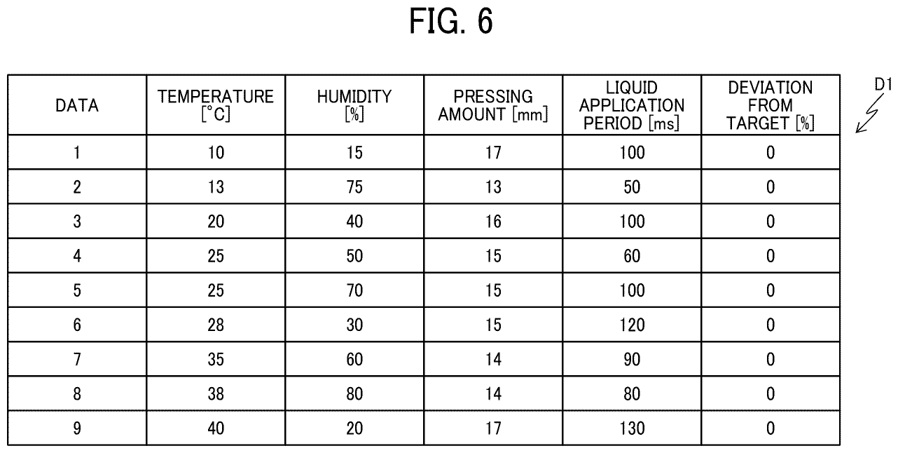

When specifying the liquid application amount, first, an approximate value of the liquid application amount is acquired based on information of temperature and humidity as environmental information when the liquid application is performed (step S501). In step S501, a table in which the temperature and humidity for acquiring the binding force and the liquid application amount (the pressing amount and liquid application period of the liquid application member 42) are associated with each other as illustrated the table in FIG. 6 is prepared in advance, and the liquid application amount is obtained from the temperature and humidity at the time of liquid application.

FIG. 6 is a diagram illustrating an example of a data table of temperature and humidity and a liquid application amount.

This table is referred to as a “first data table D1”.

The first table D1 is initially created based on the relation between the temperature and humidity and the liquid application amount obtained at the time of designing and evaluating. The information of temperature and humidity is acquired by, for example, providing a temperature and humidity sensor in the image forming apparatus 2 or the medium processing apparatus 3. For example, when the temperature and humidity sensor of the image forming apparatus 2 or the medium processing apparatus 3 detects a temperature of 25° C. and a humidity of 60%, the pressing amount of 15 mm and the liquid application period of 80 ms are determined with reference to the dataset of values “4” and “5” in data columns of the first data table D1.

Then, in order to take into consideration on operation failures due to mechanical errors or wear of the stapleless stapler 5 and sheet environments at customers, it is confirmed whether there is past information (past data) regarding the liquid application amount (step S502). When there is no past data (NO in step S502), the liquid is applied on the sheet P based on the pressing amount and the liquid application period acquired from the first data table D1 (step S504). The pattern in which no past data exists is usually the first time a medium processing apparatus is installed at the customer site.

Then, the moisture content absorbed by the sheet P is detected by the moisture content detection sensor 43, and a deviation between the moisture content to obtain the binding force (target value) and the moisture content detected by the moisture content detection sensor 43 is calculated (step S505). The deviation calculated by, for example, “Equation 1”.

Deviation from the target moisture content (%)=moisture content detected by the moisture content detection sensor—moisture content to obtain the binding force (%) . . . Equation 1.

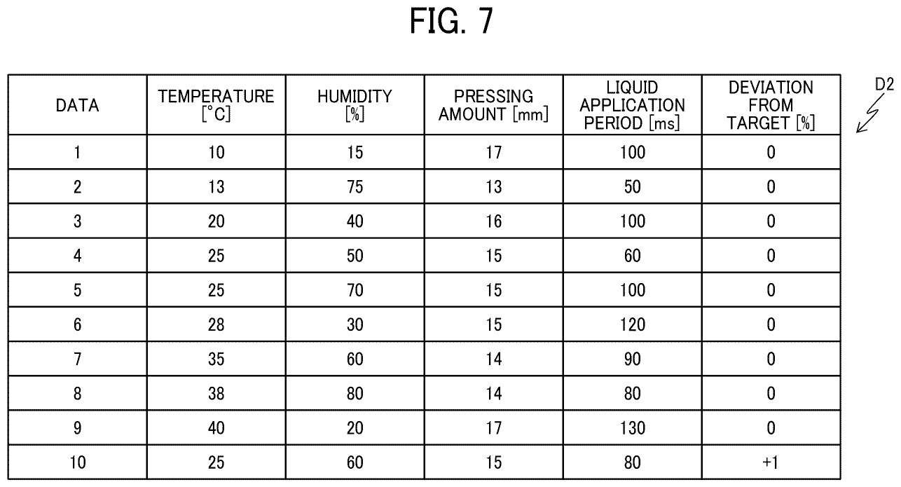

Then, information of the deviation from the target moisture content calculated in step S505 is additionally stored in the first data table D1 (step S506). For example, if the deviation from the target moisture content calculated in step S505 is +1%, the data of the deviation is additionally held (stored) as a dataset of the value “10” of the data columns of a second data table D2 illustrated in FIG. 7. FIG. 7 is a diagram illustrating a table including the line of the value “10” added to the data column of the first data table D1 of FIG. 6. The data table illustrated in FIG. 7 is referred to as the “second data table D2”. When there is no past data, the liquid application amount is specified as described above, and new data is added to the data table each time. By so doing, the first data table D1 is updated to the second data table D2. Then, when step S501 is executed for specifying the next liquid application amount, the first data table D1 (FIG. 6) is not used but the second data table D2 (FIG. 7) that is updated from the first data table D1 is used.

On the other hand, when there is past data (YES in step S502), the liquid application amount to which the correction value is added is specified (step S503). For example, when the temperature and humidity sensor of the image forming apparatus 2 or the medium processing apparatus 3 detected the temperature of 25° C. and the humidity of 60% in the state after the data table that is used in step S501 is updated from the first data table D1 (FIG. 6) to the second data table D2 (FIG. 7), the pressing amount of 15 mm and the liquid application period of 80 ms are determined with reference to the dataset of the value “10” in the data column of the second data table D2.

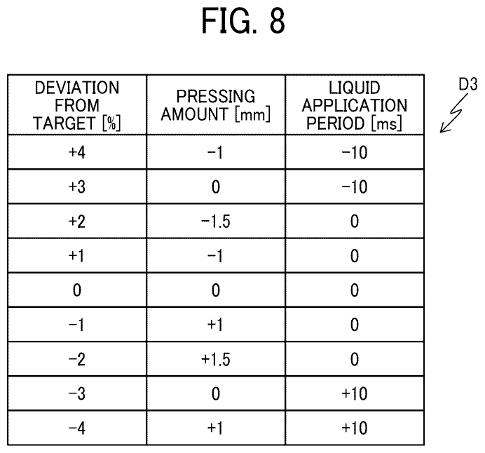

In a case where the past data exists, the liquid application based on the pressing amount and the liquid application period specified from the second data table D2 is not performed immediately, but the liquid application is performed after correcting the deviation from the target moisture content in order to take into consideration on, for example, the operation failures due to mechanical errors or wear of the stapleless stapler 5 and the sheet environments where the medium processing apparatus 3 is operated. In correcting the error, a data table is prepared in advance to represent the relation of the pressing amount and the liquid application period for correcting the deviation from the target moisture content to ±0%. Specifically, a data table in which a deviation from the target moisture content and the pressing amount and the liquid application period are associated with each other as illustrated in FIG. 8 is prepared in advance.

FIG. 8 is a diagram illustrating an example of a data table of correction values of the liquid application amount.

This table is referred to as a “third data table D3”.

The correction values in the table illustrated in FIG. 8 are examples, and the correction values are not limited to the values illustrated in the drawing. Further, the items are not limited to the pressing amount and the liquid application period, and for example, information such as the sheet type and the sheet thickness may be added so that the correction can be performed more finely and accurately.

For example, when the deviation of +1% from the target moisture content is controlled to occur under the condition where the pressing amount of 15 mm and the liquid application time of 80 ms specified in step S501 are applied as they are, the pressing amount and the liquid application period are corrected based on the correction values when the deviation from the target moisture content is +1% in the third data table D3 (FIG. 8). In other words, in a case where the deviation from the target moisture content is +1%, the pressing amount is corrected to reduce by 1 mm (the liquid application period is not corrected), and the deviation from the target moisture content is set to ±0% by correcting the pressing amount to 14 mm and the liquid application period to 80 ms. When the correction is completed, the liquid application to the sheet P is performed with the pressing amount of 14 mm and the liquid application period of 80 ms (step S504).

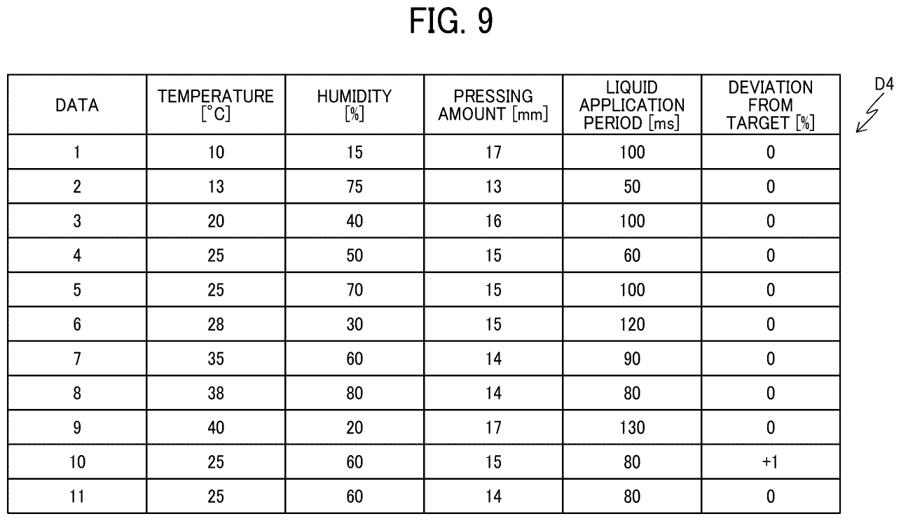

After the liquid is applied to the sheet P, the moisture content absorbed by the sheet P is detected by the moisture content detection sensor 43, and a deviation between the moisture content to obtain the binding force (target moisture content) and the moisture content detected by the moisture content detection sensor 43 is calculated (step S505). Then, the information of the deviation with the moisture content calculated in step S505 is additionally saved in the second data table D2 (FIG. 7) (step S506). For example, the current result is saved (stored) as data including an error of ±0% with respect to the target moisture content, with the data set of the value “11” added to the data column as in the data table illustrated in FIG. 9.

FIG. 9 is a diagram illustrating a table including the value “11” added to the data column of the data table of FIG. 7.

This table is referred to as a “fourth data table D4”.

The fourth data table D4 is used in step S501 when the liquid application amount is specified further in the subsequent crimp binding operation. If the temperature of 25° C. and the humidity of 60% of the operating environment are detected in the subsequent crimp binding operation, the data included in the datasets of the values “10” and “11” of the data columns in the fourth data table D4 (FIG. 9) are used. In this case, the latest data added in step S506 is weighted so that each of the data included in the dataset having the value “11” in the data column is employed. By repeating this operation, the optimum liquid application operation amount and the binding force according to the operating environment of the customer can be provided. As described above, the “past data (past information)” represents the data that is set in the latest data table among the data tables updated after the first date table D1, and the latest data table is, for example, the fourth data table D4 (see FIG. 9) in the above description.

### Identification of Liquid Application Amount by Machine Learning

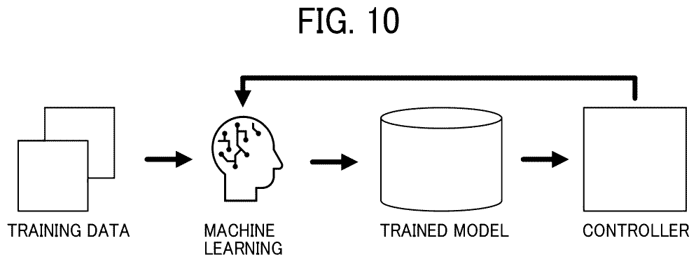

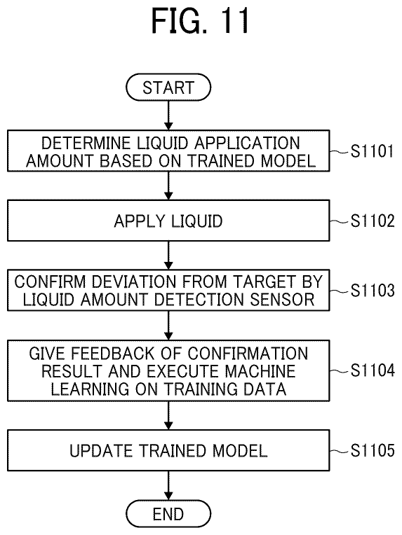

In the process of specifying the liquid application amount described above, an appropriate liquid application amount may be specified using machine learning. A description is given below of the process of specifying the liquid application amount by machine learning, with reference to FIGS. 10 and 11.

FIG. 10 is a diagram illustrating an overview of a generation step and utilization of a trained model.

FIG. 11 is a flowchart of a process of specifying a liquid application amount using machine learning.

As illustrated in FIG. 10, in the present disclosure, a trained model is generated by performing machine learning on training data created from the data obtained by evaluation at the time of design. The generated trained model is stored in, for example, an external information processing apparatus that can be connected via a communication network. A controller 300 of the medium processing apparatus 3 that is to be described below calculates information to be used for specifying the liquid application amount (the pressing amount and the liquid application period) from the trained model, and determines the control. In addition, since the determined control is fed back to perform machine learning is performed, an appropriate trained model for each customer is generated.

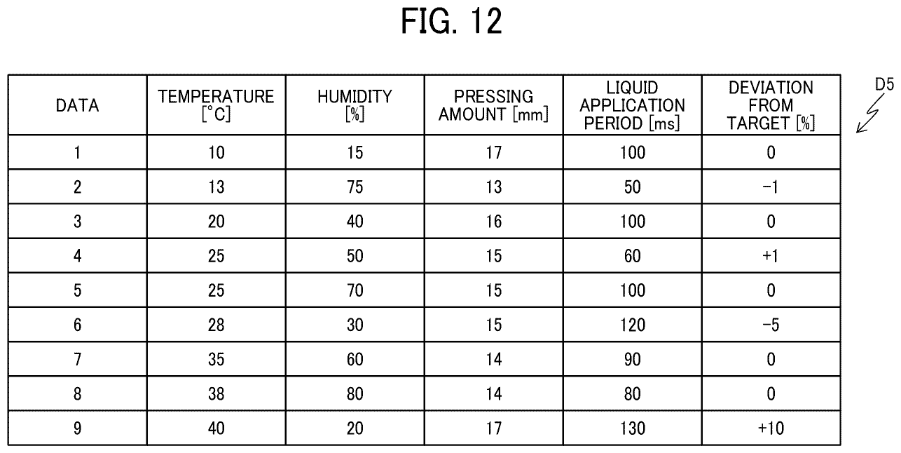

In the case of specifying the liquid application amount to be used for machine learning, the liquid application amount is determined based on the trained model as illustrated in the flowchart of FIG. 11 (step S1101). Specifically, in step S1101, a data table associating temperature, humidity, liquid application amounts (i.e., pressing amount, liquid application period), and deviations from the target moisture amount (deviation between moisture amounts) is prepared, as illustrated in FIG. 12.

FIG. 12 is a diagram illustrating an example of a data table prepared as training data.

This table is referred to as a “fifth data table D5”.

The fifth data table D5 represents how much deviation is present between the target moisture content and the moisture content when the pressing amount and the liquid application period are set to predetermined values at certain temperature and humidity.

For example, the data set of the value “1” in the data columns of the fifth data table D5 indicates that the deviation from the target moisture content is 0% when the liquid is applied with the pressing amount of 17 mm and the liquid application period of 100 ms at the temperature of 10° C. and the humidity of 15%. Based on the training data, the relation of the temperature and humidity and the liquid application amount is learned and analyzed to generate a trained model. The learning content is to estimate the pressing amount and the liquid application time from the temperature and humidity conditions. In addition, the weight of new data is increased and the weight of old data is decreased in the training data added at the customer site. By so doing, the pressing amount and the liquid application period according to the latest environment can be estimated. Further, when the data is learned together with the deviation from the target moisture content, the pressing amount and the liquid application time in consideration of, for example, the mechanical error of the stapleless stapler 5 installed at the customer site and the sheet environment.

For example, in a case where the data included in the dataset of the value “9” in the data columns of the fifth data table D5 is trained with the data of temperature and humidity and the liquid application amount as they are, the trained model is additionally trained with the result that the deviation of +10% from the target moisture content of is generated. For this reason, a prediction calculation is performed on the liquid application amount at which the deviation from the target moisture content becomes 0% before performing additional learning, and the additional learning in which the derived liquid application amount and the temperature and humidity data are associated with each other is performed. By so doing, the accuracy of the estimation to which the trained model according to the present embodiment is applied can be increased.

The liquid application amount is determined based on the information of the temperature and humidity when the liquid application is performed using the trained model generated in this manner. Even when machine learning is used, the information of the temperature and humidity is acquired by, for example, a temperature and humidity sensor provided in the image forming apparatus 2 or the medium processing apparatus 3.

When the liquid application amount is determined by the trained model, the liquid is applied to the sheet P with the determined liquid application amount (step S1102). After the liquid application, the moisture content absorbed by the sheet P is detected by the moisture content detection sensor 43, and it is confirmed whether the liquid application is performed with the target moisture content based on the deviation between the moisture content to obtain the binding force and the moisture content detected by the moisture content detection sensor 43 (step S1103). The result confirmed in step S1103 is fed back as training data and used again for the machine learning (step S1104). As a result, the trained model is updated based on the result (step S1105). As described above, the liquid application amount that is lastly fed back is determined based on the deviation from the target moisture content. By so doing, the liquid can be applied to the sheet with an appropriate liquid application amount in consideration of the mechanical error of the stapleless stapler 5 and the sheet condition.

### Failure Correction of Stapleless Stapler 5

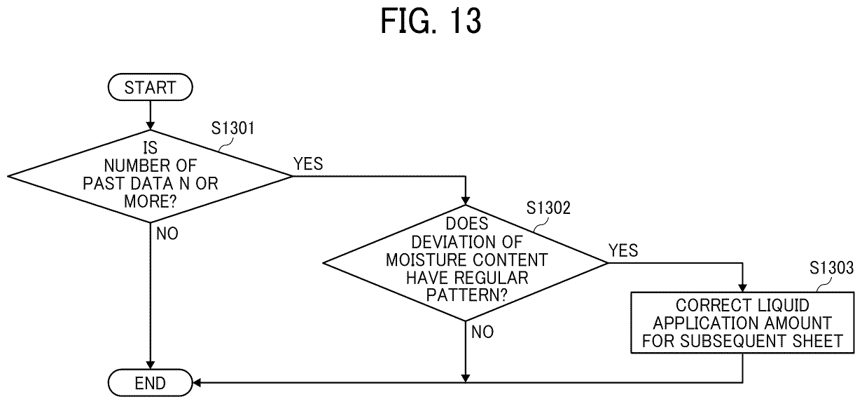

In the above-described crimp binding operation, for example, in a case where a deviation occurs in a certain direction each time with respect to the detection result of the moisture content detection sensor 43, it may be determined that there is a problem due to the stapleless stapler 5, and the amount of water absorption of the sheet P may be brought close to an appropriate value by adding a correction value in advance. A description is given below of the process in this case, with reference to FIG. 13.

FIG. 13 is a flowchart of an example of a process of a defect of the stapleless stapler 5.

First, it is determined whether the number of datasets (past data) acquired at the customer site is N or more (step S1301). When the number of datasets (past data) is less than N (NO in step S1301), the number of datasets is not sufficient to determine, and the process is terminated without correcting the defects of the stapleless stapler 5. The “number of datasets acquired at the customer site” represents the number of datasets added to the first data table D1 by use at the customer site, such as the datasets of the values “10” and “11” in the data column of the fourth data table D4 illustrated in FIG. 9.

“N” is a value of 2 or more, and the number of datasets and a certain interval have a relation of “the number of past data≥the certain interval”. In this case, when the number of datasets acquired at the customer site is 5 (YES in step S1301), the process proceeds to step S1302. In step S1302, it is determined whether any deviation of moisture content having the regularity (regular pattern) occurs at the certain interval in the 5 datasets (the number of past data) acquired at the customer site.

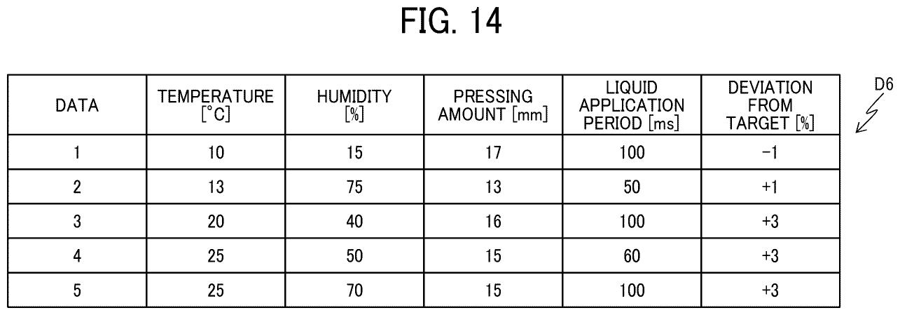

Specifically, a data table in which temperature, humidity, a liquid application amount (i.e., pressing amount, liquid application period), and a deviation from the target moisture content are associated with each other as illustrated in FIG. 14 is used.

FIG. 14 is a diagram illustrating an example of a data table of temperature, humidity and a liquid application amount with respect to a first sheet of each copy (e.g., sheet bundle).

This table is referred to as a “sixth data table D6”.

In the present embodiment, a “copy” may be used as a unit of a sheet bundle (media bundle) on which the crimp binding operation is performed. Accordingly, the “first sheet of each copy” represents the first sheet of each sheet bundle in multiple sheet bundles (copies). In addition, although the sixth data table D6 illustrated in FIG. 14 presents only the data acquired at the customer site. However, any information of the temperature, the humidity, and the liquid application amount obtained at the time of designing and evaluation may be included.

When the dataset acquired at the customer site is the content illustrated in the sixth data table D6 (FIG. 14), the deviation from the target moisture content is not always the deviation of the moisture content having the regularity (regular pattern) at the certain interval (5 datasets) (NO in step S1302). For this reason, the process ends without performing the defect correction of the stapleless stapler 5. In other words, when the datasets from the line of the value “3” of the data column to the line of the value “5” in the sixth data table D6 are compared, the data of the deviation with the target moisture content is found to be equivalent to +3% in each dataset. However, when the datasets from the line of the value “1” of the data column to the line of the value “5” in the sixth data table D6 are compared, the data of the deviation with the target moisture content varies in each dataset, and it is difficult to determine whether there is regularity.

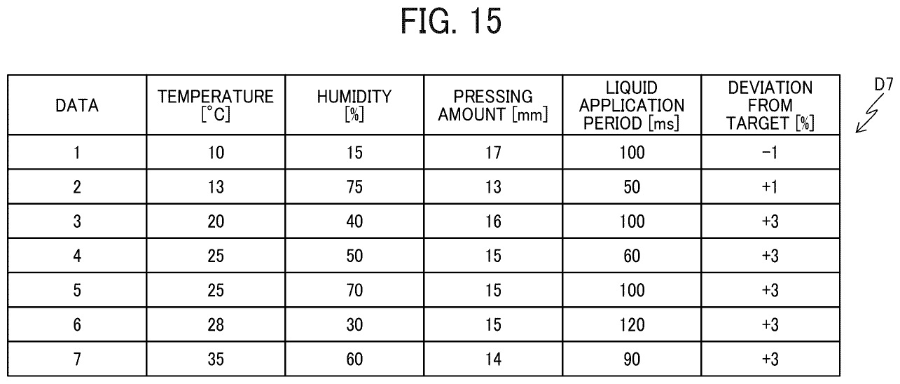

Subsequently, the data table to which two datasets are added by the user of the medium processing apparatus 3 is illustrated in FIG. 15.

FIG. 15 is a diagram illustrating a table including the datasets of the values “6” and “7” of the data columns added to the sixth data table D6 of FIG. 14.

This table is referred to as a “seventh data table D7”.

For example, when step S1302 is performed based on the seventh data table D7 to which the datasets of the values “6” and “7” of the data columns are added, the deviation of +3% from the target moisture content occurs in the certain interval (five datasets), for example, the five datasets from the values “3” to “7” of the data columns, and it is determined that the determination of the amount of moisture content having the regularity (regular pattern) sequentially occurs in the certain interval (YES in step S1302).

When it is determined that the deviation of the moisture content having the regularity (regular pattern) occur in the certain section, it is determined that the stapleless stapler 5 is defective, and the liquid application amount to the subsequent sheets is corrected (step S1303). Specifically, in the configuration in which the liquid application amount is specified without using the machine learning, the correction is performed using the pressing amount (value “0 ” in the example of the third data table D3) and the liquid application period (value “−10 ms” in the example of the third data table D3) as the correction values in a case where the deviation from the target moisture content is +3% from the third data table D3 (FIG. 8). Further, in the configuration in which the liquid application amount is specified using machine learning, a correction value at which the deviation from the target moisture content becomes 0% is predicted and calculated based on the trained model to correct the moisture content. As a result, the liquid application amount of the subsequent copies is corrected so that the deviation from the target moisture content is ±0%. In the above description, the value of the deviation from the target moisture content is focused on the first sheet of each copy (sheet bundle), but may be focused on the last sheet (an example of the last medium) of the sheet bundle, or may be focused on the inner sheet.

### Application Example

In the configuration in which the liquid application amount is specified using the above-described machine learning, information based on the first sheet of a copy (sheet bundle) is fed back and learned as training data. In the application example described below, in the same bundle, in other words, in a sheet bundle of a single copy bound as the same sheet bundle, it is determined whether the liquid application amount is appropriate for the second and subsequent sheets. When the result is continuously significantly different from the result of the first sheet, it is determined that the state of (such as type, lot, or storage state) of the sheet has changed.

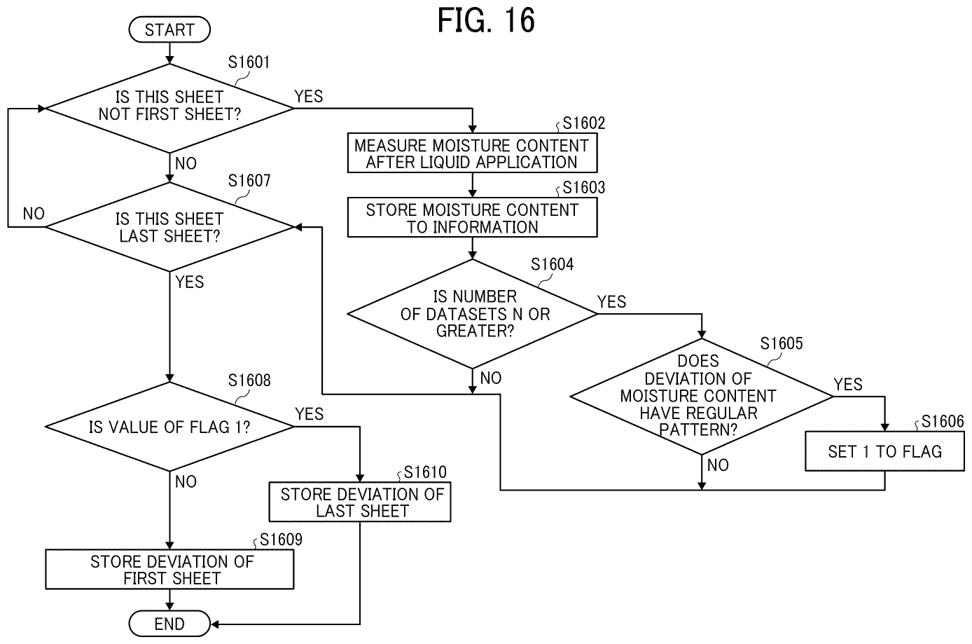

FIG. 16 is a flowchart of an example of a process corresponding to a change in the state of a sheet.

In the case of this application example, information of the moisture content of the liquid applied to each sheet of the same copy (the same sheet bundle) is stored for each of the number of sheets (steps S1601 to S1603). When five or more datasets are acquired at the customer site, it is determined whether or not any deviation of the moisture content having regular pattern occur in the certain interval (five datasets) (steps S1604 and S1605). The number of datasets N used for the determination in step S1604 is a value of 2 or more, and the number of datasets used for the determination of the regularity (regular pattern) in step S1605 and the certain interval have a relation of “the number of past data≥the certain interval”. These conditions are the same as the conditions described in the flowchart in FIG. 13, and thus the description of the conditions is omitted.

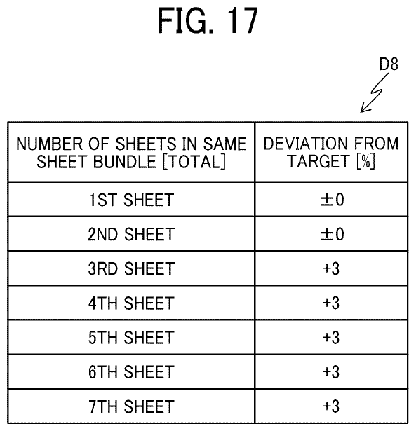

When the deviation from the target moisture content is determined with respect to each sheet of the same copy (the same sheet bundle), a data table as illustrated in FIG. 17 is used.

FIG. 17 is a diagram illustrating an example of a data table of deviations of the number of sheets of the same copy (same sheet bundle) and the target moisture content.

This table is referred to as an “eighth data table D8”.

The example of a data table illustrated in FIG. 17 represents a pattern in which a deviation error from the target moisture content having a regularity (regular pattern) occurs from the third sheet onward. As described in the eighth data table D8, when the values of the deviations from the target moisture contents of the first and second sheets of the same copy (the same sheet bundle) are continuously changed with the regular pattern from the third and subsequent sheets, it is determined that the state of the sheet is changed. In other words, the controller 300 or the controller 200 determines that deviations in the moisture content having a regular pattern occur in the certain interval (five datasets of the third to seventh sheets) (YES in step S1605). Then, the controller 300 or the controller 200 sets “1” as a flag variable (or a flag) (step S1606), and determines whether or not the current sheet currently being processed is the last sheet (step S1607).

Further, when the controller 300 or the controller 200 determines that no deviations in the moisture content having a regular pattern occur in the certain interval (five datasets of the third to seventh sheets) (NO in step S1605), the controller 300 or the controller 200 further determines whether or not the current sheet currently being processed is the last sheet (step S1607). Then, when the controller 300 or the controller 200 determines that the sheet currently being processed is not the last sheet (NO in step S1607), the controller 300 or the controller 200 repeatedly executes the processing from step S1601 to step S1607 until the controller 300 or the controller 200 determines that the sheet currently being processed is the last sheet (in other words, to be YES in step S1607).

On the other hand, when the determines that the sheet currently being processed is the last sheet (YES in step S1607), the controller 300 or the controller 200 determines whether “1” is set as a flag variable (or a flag) (step S1608). Then, when the controller 300 or the controller 200 determines that “1” is set as a flag variable (or a flag) (YES in step S1608), the controller 300 or the controller 200 does not provide feedback on the determination result of the first sheet (the deviation from the target moisture content) but provides feedback on the determination result of the last sheet (the deviation from the target moisture content) to be used as the learned data (step S1610).

In other words, since the determination result of the seventh sheet that is an example of the last sheet is the deviation of +3% from the target moisture content, information of the deviation of +3% is fed back to be used as learned data. As a result, the liquid application amount of the subsequent sheets is corrected so that the deviation from the target moisture content is ±0%. When the controller 300 or the controller 200 determines that “1” is not set as a flag variable (or a flag) (NO in step S1608), the controller 300 or the controller 200 feeds back the determination result of the first sheet (the deviation from the target moisture content, to be used as the learned data (step S1609).

### Other Data Table Examples

The management items in each data table are not limited to the above-described items.

A description is given below of another example of the data table.

### Sheet Number Management

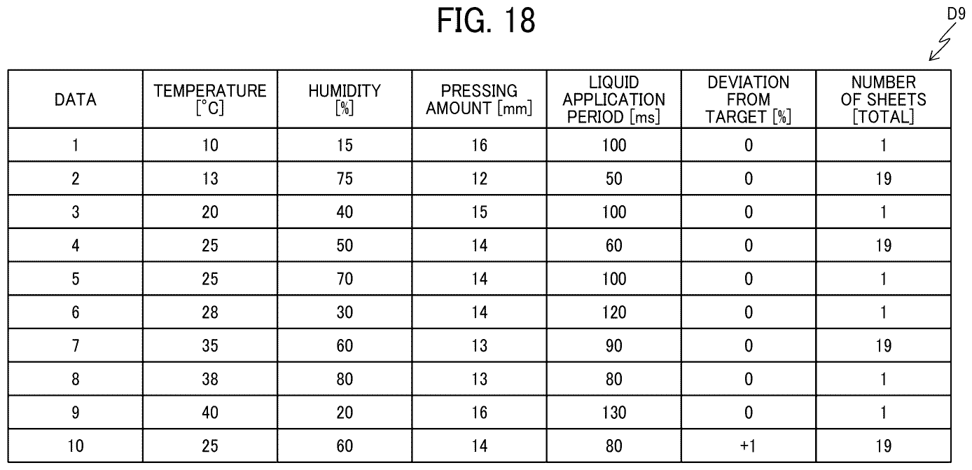

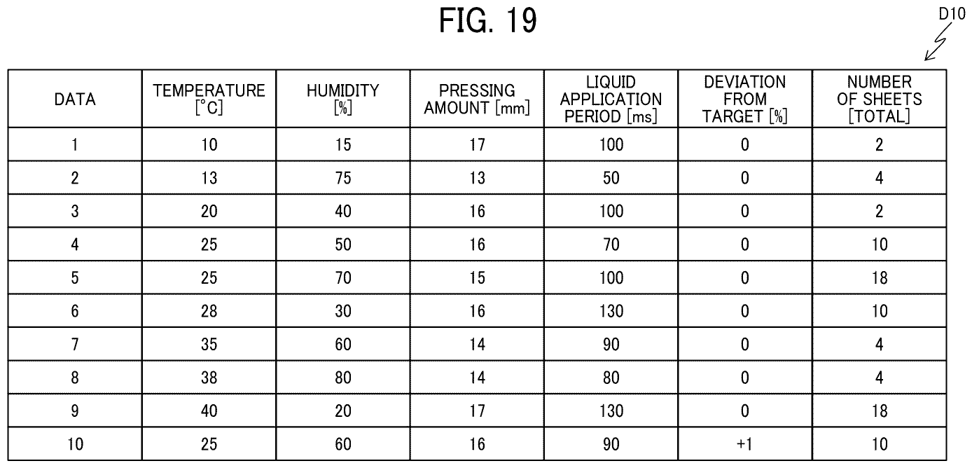

As a management item of the data table used for specifying the liquid application amount, information of “number of sheets” may be included as illustrated in FIGS. 18 and 19.

FIGS. 18 and 19 are diagrams illustrating an example of a data table related to a temperature, a humidity, a liquid application amount, and the number of sheets.

FIG. 18 illustrates an example of a data table that can manage sheets (the first sheet and the last sheet) that are outer sheets, a temperature, a humidity, and a liquid application amount are associated with each other.

This table is referred to as a “ninth data table D9”.

FIG. 19 is an example of a data table that can manage a sheet to be an inner sheet, a temperature, a humidity, and a liquid application amount associated with each other.

This table is referred to as a “tenth data table D10”.

In the crimp binding operation, the binding teeth of the binder 44 directly contact the outer sheets to perform crimp binding, and thus the fibers of the outer sheets are more likely to be entangled than the fibers of the inner sheets. Further, when the moisture content is large, the sheet is easily torn. On the other hand, the binding force of the crimp binding is less likely to be transmitted to the inner sheets as the inner sheets are closer to the center of the sheet bundle, and the fibers of the inner sheets are less likely to be entangled than the fibers of the outer sheets. Further, the moisture content is to be increased to facilitate entanglement of the fibers of the sheet. Accordingly, by managing the number of sheets in association with each other, an appropriate liquid application amount can be specified in consideration of the ease of entanglement of the fibers that changes for each of the numbers of sheets. In the above description, the data tables are divided for the outer sheets and the inner sheets. However, the data tables may be managed by one data table or may be further subdivided.

In a case where the ninth data table D9 and the tenth data table D10 are applied to the configuration in which the liquid application amount is specified without executing the machine learning, for example, the first data table D1 (FIG. 6) used in step S501 in FIG. 5 may be replaced to the ninth data table D9 and the tenth data table D10, so that the liquid application amount further in consideration of the number of sheets can be specified.

Further, in a case where the ninth data table D9 and the tenth data table D10 are applied to the configuration in which the liquid application amount is specified without executing the machine learning, for example, the fifth data table D5 (FIG. 12) used in step S1101 in FIG. 11 may be replaced to the ninth data table D9 and the tenth data table D10, so that the liquid application amount further in consideration of the number of sheets can be specified.

### Sheet Type Management

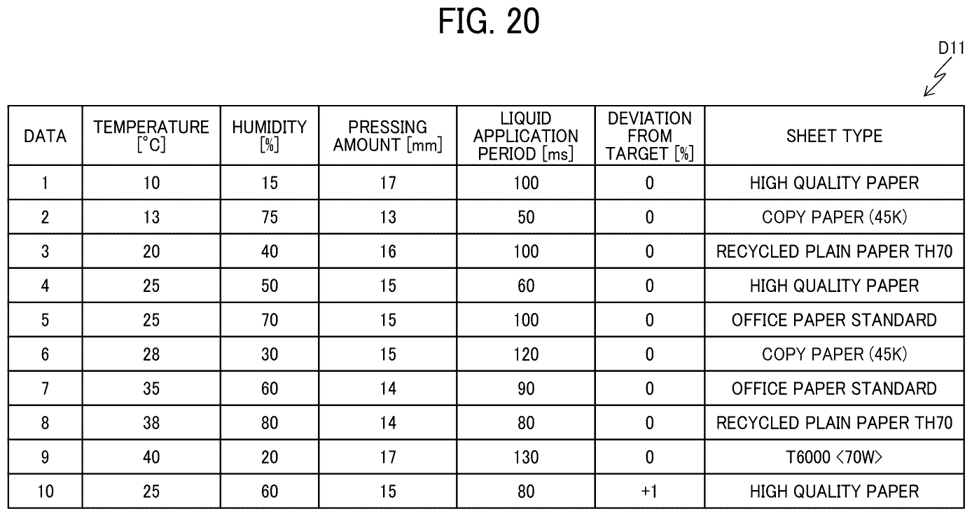

Further, as a management item of the data table used for specifying the liquid application amount, information of “sheet type” may be included as illustrated in FIG. 20. FIG. 20 is a diagram illustrating an example of a data table related to temperature and humidity, liquid application amount, and sheet type.

This table is referred to as an “eleventh data table D11”.

FIG. 20 illustrates an example of a data table that can manage the sheet type, the temperature, the humidity, and the liquid application amount associated with each other.

The information of the sheet type can be set from, for example, the operation unit 4 of the image forming apparatus 2, and can be acquired from, for example, the image forming apparatus 2. By including information of the sheet type in addition to the environmental information (temperature and humidity) and the information relating to the liquid application amount (the pressing amount and the liquid application period of the liquid application member 42), an appropriate liquid application amount can be specified in consideration of the water absorbency that is different for each sheet type.

In a case where the eleventh data table D11 is applied to the configuration in which the liquid application amount is specified without executing the machine learning, for example, the first data table D1 (FIG. 6) used in step S501 in FIG. 5 may be replaced to the eleventh data table D11, so that the liquid application amount further in consideration of the sheet type can be specified.

Further, in a case where the eleventh data table D11 is applied to the configuration in which the liquid application amount is specified without executing the machine learning, for example, the fifth data table D5 (FIG. 12) used in step S1101 in FIG. 11 may be replaced to the eleventh data table D11, so that the liquid application amount further in consideration of the sheet type can be specified.

### Sheet Thickness Management

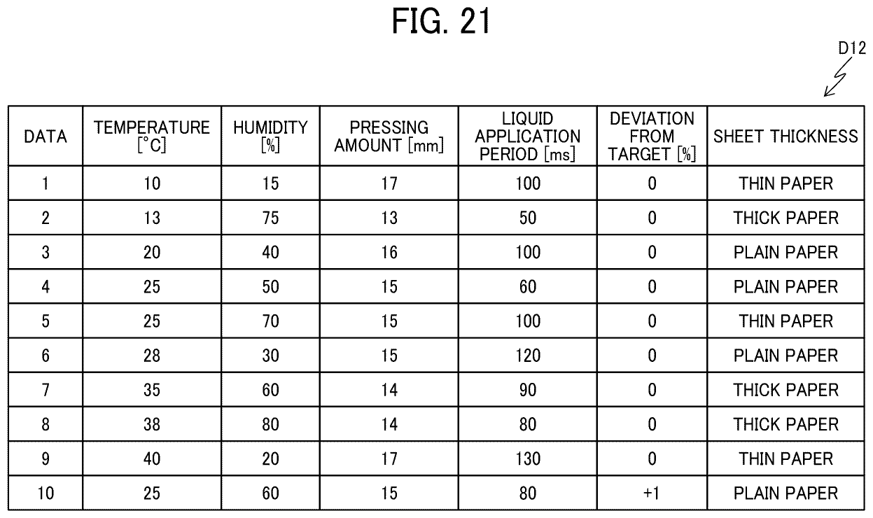

Further, as a management item of the data table used for specifying the liquid application amount, information of “sheet thickness” may be included as illustrated in FIG. 21.

FIG. 21 is a diagram illustrating an example of a data table related to temperature and humidity, liquid application amount, and sheet thickness.

This table is referred to as a “twelfth data table D12”.

FIG. 21 illustrates an example of a data table that can manage the sheet thickness, the temperature, the humidity, and the liquid application amount associated with each other.

As in the case of the sheet type described above, the information of the sheet thickness can be set from, for example, the operation unit 4 of the image forming apparatus 2, and can be acquired from, for example, the image forming apparatus 2. By including information of the sheet thickness in addition to the environmental information (temperature and humidity) and the information of the liquid application amount (the pressing amount and the liquid application period of the liquid application member 42), an appropriate liquid application amount can be specified in consideration of the water absorbency that is different for each sheet thickness.

In a case where the twelfth data table D12 is applied to the configuration in which the liquid application amount is specified without executing the machine learning, for example, the first data table D1 (FIG. 6) used in step S501 in FIG. 5 may be replaced to the twelfth data table D12, so that the liquid application amount further in consideration of the sheet thickness can be specified.

Further, in a case where the twelfth data table D12 is applied to the configuration in which the liquid application amount is specified without executing the machine learning, for example, the fifth data table D5 (FIG. 12) used in step S1101 in FIG. 11 may be replaced to the twelfth data table D12, so that the liquid application amount further in consideration of the sheet thickness can be specified.

### Liquid Management

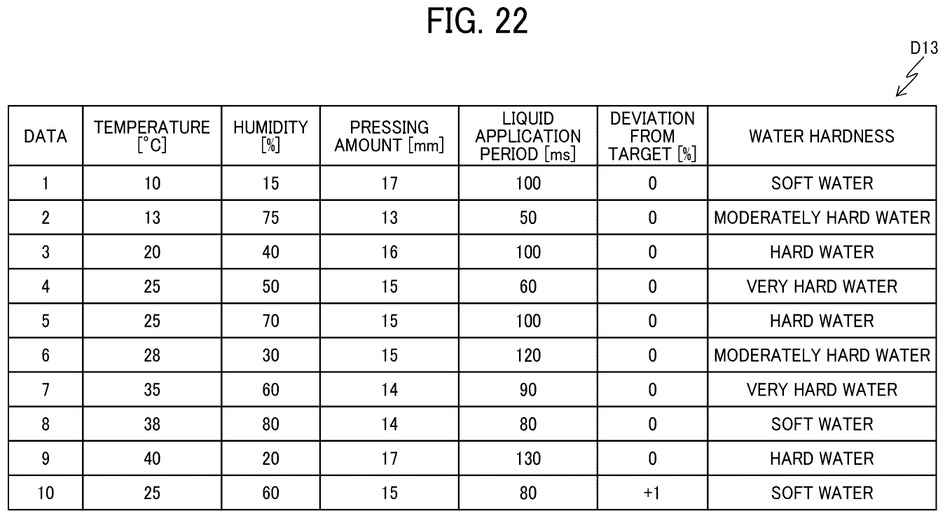

Further, as a management item of the data table used for specifying the liquid application amount, information of “liquid type” may be included. Since the liquid used in the crimp binding process is mainly water, “hardness of water” is illustrated as the information of the type of water in the data table illustrated in FIG. 22.

FIG. 22 is a diagram illustrating an example of a data table related to temperature and humidity, liquid application amount, and water type.

This table is referred to as a “thirteenth data table D13”.

FIG. 22 illustrates an example of a data table that can manage the hardness of water, the temperature, the humidity, and the liquid application amount associated with each other.

The information of the liquid type (hardness) can be set from, for example, the operation unit 4 of the image forming apparatus 2, and can be acquired from, for example, the image forming apparatus 2. By including information of the liquid type (hardness) in addition to the environmental information (temperature and humidity) and the information of the liquid application amount (the pressing amount and the liquid application period of the liquid application member 42), an appropriate liquid application amount can be specified in consideration of the degree of permeation to different sheets for each liquid type (hardness).

In a case where the thirteenth data table D13 is applied to the configuration in which the liquid application amount is specified without executing the machine learning, for example, the first data table D1 . FIG. 6) used in step S501 in FIG. 5 may be replaced to the thirteenth data table D13, so that the liquid application amount further in consideration of the liquid type (hardness) can be specified.

Further, in a case where the thirteenth data table D13 is applied to the configuration in which the liquid application amount is specified without executing the machine learning, for example, the fifth data table D5 (FIG. 12) used in step S1101 in FIG. 11 may be replaced to the thirteenth data table D13, so that the liquid application amount further in consideration of the liquid type (hardness) can be specified.

### Fixing Temperature Management

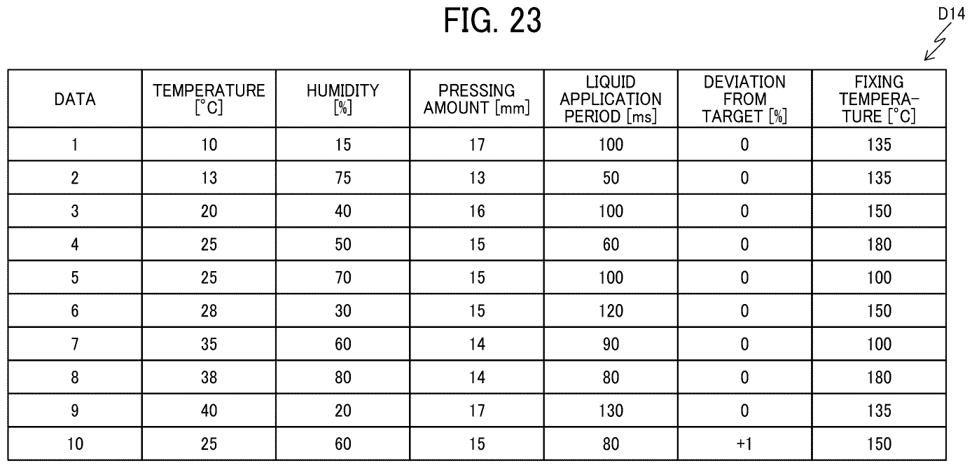

Further, as a management item of the data table used for specifying the liquid application amount, information of “fixing temperature” may be included as illustrated in FIG. 23.

FIG. 23 is a diagram illustrating an example of a data table related to temperature and humidity, liquid application amount, and fixing temperature.

This table is referred to as a “fourteenth data table D14”.

FIG. 23 illustrates an example of a data table that can manage the fixing temperature, the temperature, the humidity, and the liquid application amount associated with each other.

The information of the fixing temperature can be acquired based on the detection result of the fixing temperature sensor included in the image forming apparatus 2. When the fixing temperature is high, the sheet passing through the fixing unit becomes hot. When the liquid is applied to the sheet in this state, the moisture is likely to evaporate. On the other hand, when the fixing temperature is a normal temperature, the sheet passing through the fixing unit is less likely to be heated than when the temperature is high. When the liquid is applied to the sheet in this state, the moisture is less likely to evaporate. Accordingly, by including information of the fixing temperature in addition to the environmental information (temperature and humidity) and the information of the liquid application amount (the pressing amount and the liquid application period of the liquid application member 42), an appropriate liquid application amount can be specified in consideration of the degree of evaporation of liquid.

In this example, the information of the fixing temperature is acquired from the image forming apparatus 2. However, the fixing temperature may be calculated from the interval (time) of the sheet fed to the medium processing apparatus 3. When the sheet interval is long, the temperature of the fixing unit decreases with time, and conversely, when the sheet interval is short, the fixing unit is fully operated and the fixing temperature increases. For these reasons, even in a case where information of the sheet interval sent to the medium processing apparatus 3 is used, an appropriate liquid application amount can be specified in consideration of the degree of evaporation of liquid.

In a case where the fourteenth data table D14 is applied to the configuration in which the liquid application amount is specified without executing the machine learning, for example, the first data table D1 (FIG. 6) used in step S501 in FIG. 5 may be replaced to the fourteenth data table D14, so that the liquid application amount further in consideration of the degree of evaporation of liquid can be specified.

Further, in a case where the fourteenth data table D14 is applied to the configuration in which the liquid application amount is specified without executing the machine learning, for example, the fifth data table D5 (FIG. 12) used in step S1101 in FIG. 11 may be replaced to the fourteenth data table D14, so that the liquid application amount further in consideration of the degree of evaporation of liquid can be specified.

### Combination of Data Tables

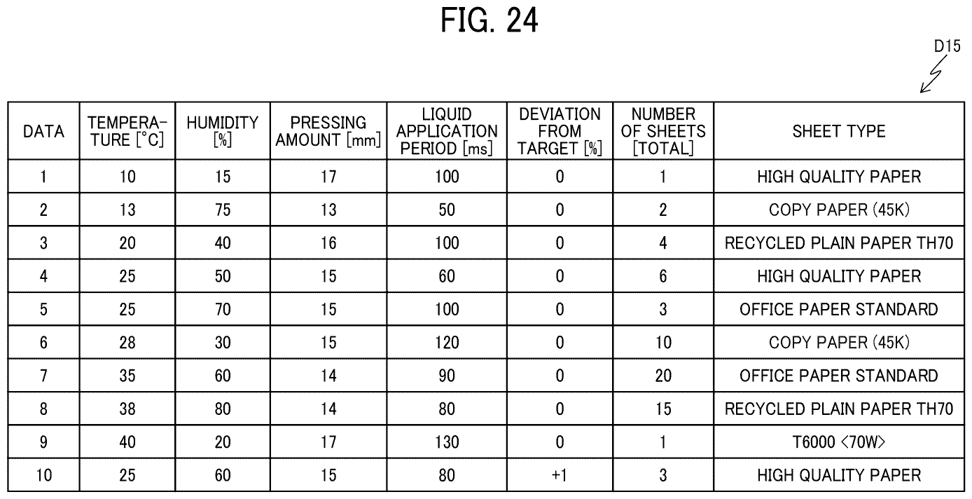

By managing various data tables (the first data table D1 to the fourteenth data table D14) used for specifying the liquid application amount in combination, a more optimal liquid application amount can be specified. For example, as illustrated in FIG. 24, information of the “number of sheets” and the “sheet type” may be combined.

FIG. 24 is a diagram illustrating an example of a data table related to temperature and humidity, liquid application amount, the number of sheets, and sheet type.

This table is referred to as a “fifteenth data table D15”.

FIG. 24 illustrates an example of a data table that can manage the number of sheets, the temperature, the humidity, and the liquid application amount associated with each other. The associated information is not limited to the two datasets, i.e., the number of sheets and the sheet type, and may be a combination of multiple types of information, such as the sheet thickness, liquid type, and the fixing temperature, as illustrated in the first data table D1 to the fourteenth data table D14 described above.

In a case where the fifteenth data table D15 is used, the information of the number of sheets and the sheet type is included in addition to the environmental information (temperature and humidity) and the information of the liquid application amount (the pressing amount and the liquid application period of the liquid application member 42). By so doing, an appropriate liquid application amount can be specified in consideration of the degree of permeation to different sheets for the number of sheets and the sheet type.

In a case where the fifteenth data table D15 is applied to the configuration in which the liquid application amount is specified without executing the machine learning, for example, the first data table D1 (FIG. 6) used in step S501 in FIG. 5 may be replaced to the fifteenth data table D15, so that the liquid application amount further in consideration of the degree of permeation to different sheets depending on the number of sheets and the sheet type can be specified.

In a case where the fifteenth data table D15 is applied to the configuration in which the liquid application amount is specified without executing the machine learning, for example, the fifth data table D5 (FIG. 12) used in step S1101 in FIG. 11 may be replaced to the fifteenth data table D15, so that the liquid application amount further in consideration of the degree of permeation to different sheets depending on the number of sheets and the sheet type can be specified.

### Configuration Example of Image Forming System Using Trained Model (Schematic Configuration)

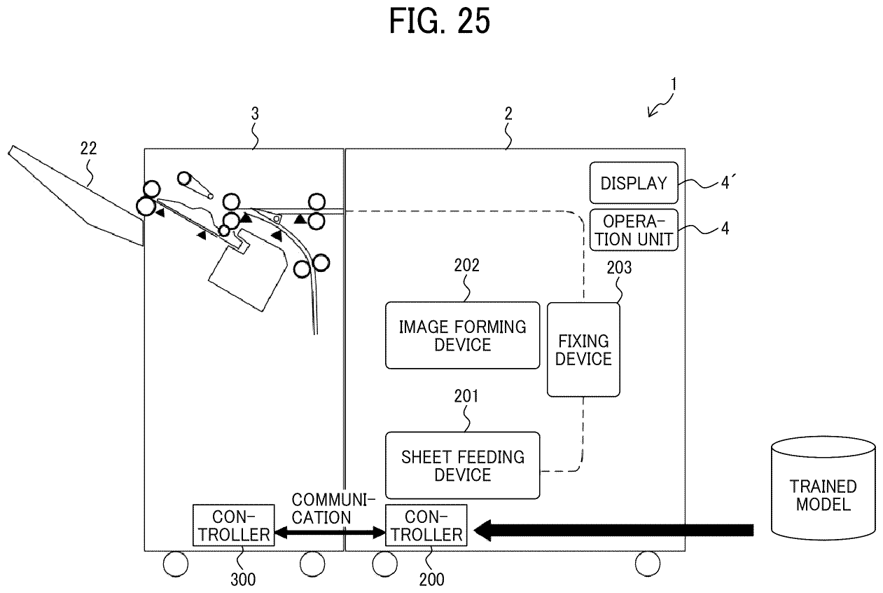

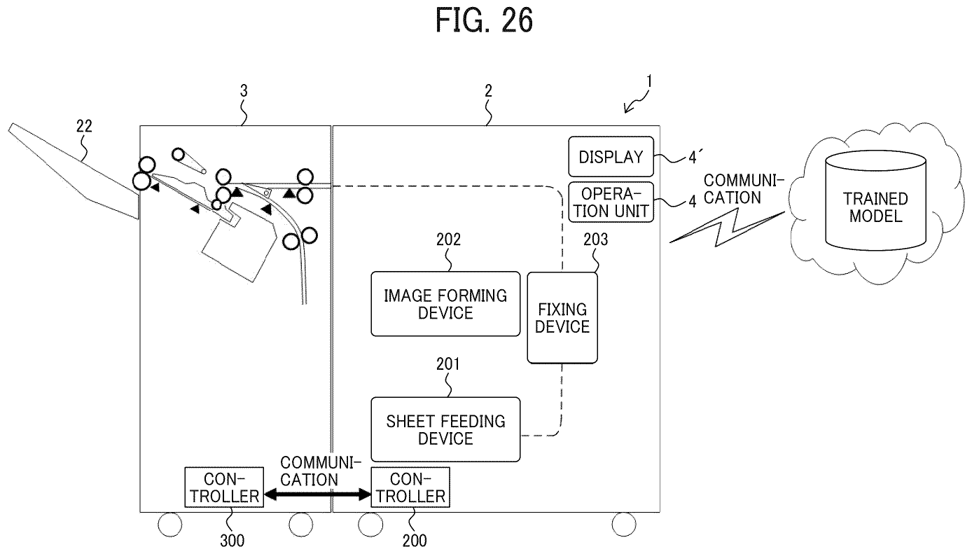

A description is given below of the relation of the image forming system 1 and a trained model, with reference to FIGS. 25 and 26.

FIG. 25 is a diagram illustrating an example of the configuration of an image forming system including a trained model.

FIG. 26 is a diagram illustrating the configuration of an image forming system including a trained model in a cloud system.

The image forming system 1 includes the image forming apparatus 2 and the medium processing apparatus 3. The image forming apparatus 2 includes, for example, a sheet feeding device 201, an image forming device 202, and a fixing device 203. The sheet feeding device 201 accommodates multiple sheets and feeds the sheets one by one to the fixing device 203. The image forming device 202 forms an image to be formed on a sheet fed from the sheet feeding device 201. The image formed by the image forming device 202 is transferred via a transferring mechanism at the position upstream from the fixing device 203 in the sheet conveyance direction. The fixing device 203 heats and presses the sheet with the image to fix the image to the sheet. The sheet to which the image is fixed is conveyed from the image forming apparatus 2 and is conveyed to the medium processing apparatus 3 that is disposed downstream from the image forming apparatus 2 in the sheet conveyance direction.

The medium processing apparatus 3 performs a given post-processing operation on the sheet that is received by the medium processing apparatus 3, and ejects the sheet to the sheet ejection tray 22. The image forming apparatus 2 includes the operation unit 4 to set, for example, the image formation mode, and a display unit 4′ to confirm the status of the image forming apparatus 2. The image forming apparatus 2 and the medium processing apparatus 3 are communicably coupled to each other via the controller 200 and the controller 300. The image forming apparatus 2 is disposed upstream from the medium processing apparatus 3 in the sheet conveyance direction and is coupled to the medium processing apparatus 3 at the upstream position in the sheet conveyance direction. Further, the image formation method that can be employed by the image forming apparatus 2 is not limited to an electrophotographic method but is applicable to other image formation method such as an inkjet method.

In the image forming system 1 having the above-described configuration, the trained model generated by machine learning is a part of the control program. For this reason, the trained model is not limited to the trained model deployed in the controller 300 of the medium processing apparatus 3, and may be deployed in the controller 200 of the image forming apparatus 2, or may be deployed in an external information processing apparatus other than the image forming apparatus 2 and the medium processing apparatus 3. For example, the trained model may be deployed as a part of the control program written to the controller 200 of the image forming apparatus 2 that communicates with the medium processing apparatus 3, as illustrated in FIG. 25. Typically, the image forming apparatus 2 has a function of setting sheet information and print information. Due to such a configuration, the liquid application amount can be estimated using the sheet information and the print information.

The trained model may be deployed on a cloud system (information processing apparatus) communicably coupled to the image forming apparatus 2 via a communication network. In this case, the sheet information and the print information for specifying (estimating) the liquid application amount can be transmitted from the image forming apparatus 2 to the cloud system, and the liquid application amount can be specified on the cloud system.

Alternatively, the trained model may be deployed in the cloud system and may be downloaded to the image forming apparatus 2 at the timing when the power of the image forming apparatus 2 is turned on. As a result, no communication is to be done between the image forming apparatus 2 and the cloud system, and the time from the print job instruction by the user to the print start can be reduced. The communication with the cloud system may not be performed by the image forming apparatus 2 but may be performed by the medium processing apparatus 3, so that the medium processing apparatus 3 can specify (or estimate) the liquid application amount.

A detailed description is given below of the system illustrated in FIG. 26.

### Hardware Configuration of Image Forming Apparatus 2

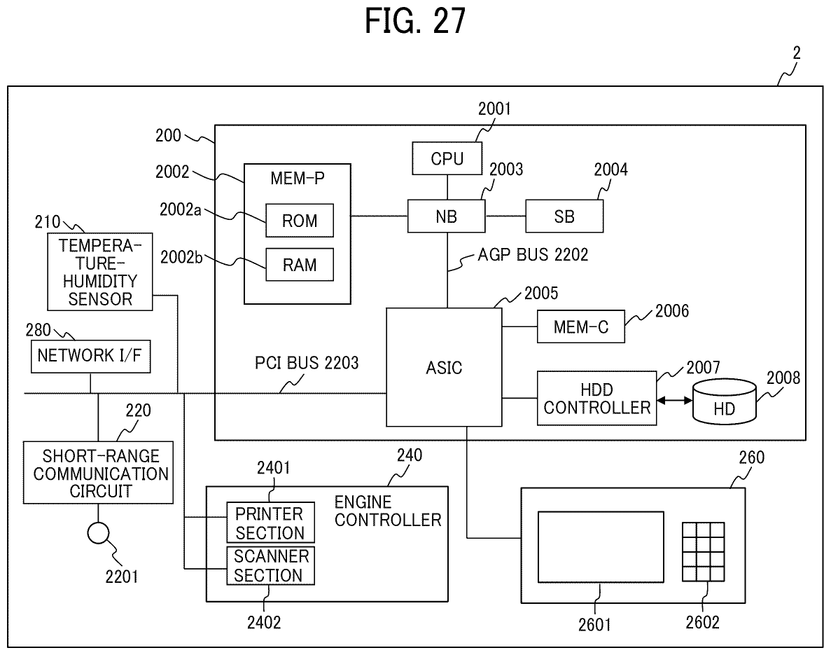

FIG. 27 is a diagram illustrating a hardware configuration of the image forming apparatus 2.

The image forming apparatus 2 includes a controller 200, a short-range communication circuit 220, an engine controller 240, a control panel 260, and a network interface (I/F) 280. The controller 200 includes a central processing unit (CPU) 2001 as a main processor, a system memory (MEM-P) 2002, a north bridge (NB) 2003, a south bridge (SB) 2004, an application specific integrated circuit (ASIC) 2005, a local memory (MEM-C) 2006 as a storage unit, a hard disk drive (HDD) controller 2007, and a hard disk (HD) 2008 as a storage unit. The NB 2003 and the ASIC 2005 are connected through an accelerated graphics port (AGP) bus 2202.

The CPU 2001 controls the entire operation of the image forming apparatus 2. The NB 2003 is a bridge to connect the CPU 2001 to the MEM-P 2002, the SB 2004, and the AGP bus 2202, and includes a memory controller to control reading and writing with respect to the MEM-P 2002, a peripheral component interconnect (PCI) master, and an accelerated graphics port (AGP) target.

The MEM-P 2002 includes a read-only memory (ROM) 2002a and a random access memory (RAM) 2002b. The ROM 2002a is a memory that stores programs and data for implementing various functions of the controller 200. The RAM 2002b is a memory that deploys the programs and data, or is used as a drawing memory that stores drawing data for printing. The program stored in the RAM 2002b may be provided as a file in an installable format or an executable format in which the program is recorded in a computer-readable storage medium such as a compact disc-read-only memory (CD-ROM), a compact disc-recordable (CD-R), or a digital versatile disc (DVD).

The SB 2004 is a bridge that connects the NB 2003 to the PCI devices and peripheral devices. The ASIC 2005 is an integrated circuit (IC) for image processing having a hardware element for image processing and has a role of a bridge that connects the AGP bus 2202, the PCI bus 2203, the HDD controller 2007, and the MEM-C 2006 to each other. The ASIC 2005 includes a PCI target, an AGP master, an arbiter (ARB) as a core of the ASIC 2005, a memory controller that controls the MEM-C 2006, multiple direct memory access controllers (DMAC) that rotates image data by hardware logic, and a PCI unit that transfers data between a printer section 2401 and a scanner section 2402 via the PCI bus 2203. An interface of a universal serial bus (USB) or an interface of an institute of electrical and electronics engineers 1394 (IEEE 1394) may be connected to the ASIC 2005.

The MEM-C 2006 is a local memory used as a copy image buffer and a code buffer. The HD 2008 is a storage (memory) that stores image data, font data used in printing, and form data. The HD 2008 controls the reading or writing of data from or to the HD 2008 under the control of the CPU 2001. The AGP bus 2202 is a bus interface for a graphics accelerator card, which has been proposed to accelerate graphics processing. Through directly accessing the MEM-P 2002 by high throughput, the speed of the graphics accelerator card increases. The short-range communication circuit 220 includes a short-range communication antenna 2201. The short-range communication circuit 220 is a communication circuit that communicates in compliance with a near field communication (NFC) or the BLUETOOTH (registered trademark), for example.

The engine controller 240 includes the printer section 2401 and the scanner section 2402. The control panel 260 includes a panel display 2601 and a control panel 2602. The panel display 2601 is, for example, a touch screen that displays current settings or a selection screen and that receives the user input. The control panel 2602 includes, for example, a numeric keypad and a start key. The numeric keypad receives set values of various image forming parameters such as an image density parameter. The start key receives an instruction to start copying. The controller 200 controls an entire operation of the image forming apparatus 2 and controls, for example, drawing, communication, and input from the control panel 260. The scanner section 2402 and the printer section 2401 include an image processing unit for performing various image processing, such as error diffusion or gamma conversion.

The image forming apparatus 2 can sequentially switch among a document server function, a copier function, a printer function, and a facsimile function in accordance with input via, for example, an application switch key on the control panel 260. When the document box function is selected, the image forming apparatus 3 operates in a document box mode. When the copier function is selected, the image forming apparatus 3 operates in a copy mode. When the printer function is selected, the image forming apparatus 3 operates in a printer mode. When the facsimile function is selected, the image forming apparatus 3 operates in a facsimile mode. The network I/F 280 is an interface for data communication with the communication network 1000. The short-range communication circuit 220 and the network I/F 280 are electrically connected to the ASIC 2205 via the PCI bus 2203. The control panel 260 corresponds to the operation unit 4 in FIG. 1.

### Hardware Configuration of Controller 300 of Medium Processing Apparatus 3 and Information Processing Apparatus (Server) 500

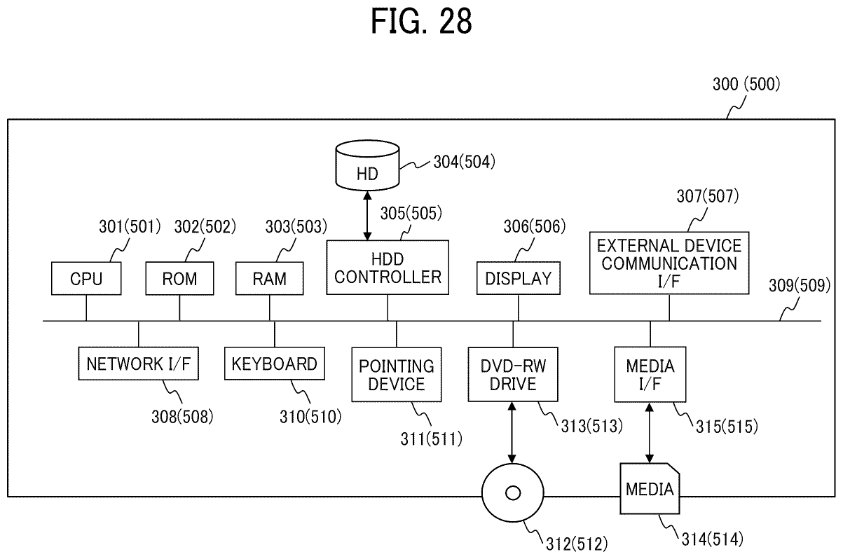

FIG. 28 is a diagram illustrating a hardware configuration of the controller 300 and the server 500 included in the medium processing apparatus 3.

The hardware configuration of the controller 300 of the media processing device 3 is denoted by a reference numeral in the 300s, and the hardware configuration of the server 500 described below is denoted by a reference numeral in the 500s.

The controller 300 is implemented by a computer and includes, for example, a central processing unit (CPU) 301, a read only memory (ROM) 302, a random access memory (RAM) 303, a hard disk (HD) 304, a hard disk drive (HDD) controller 305, a display 306, an external device connection interface (I/F) 307, a network interface (I/F) 308, a bus line 309, a keyboard 310, a pointing device 311, a DVD-RW drive 313, and a media interface (I/F) 315, as illustrated in FIG. 28.

Among these components, the CPU 301 controls the operation of the entire controller 300. The ROM 302 stores a program used for driving the CPU 301 such as an initial program loader (IPL). The RAM 303 is used as a work area of the CPU 301. The HD 304 stores various data such as programs. The HDD controller 305 controls reading or writing of various types of data from or to the HD 304 under the control of the CPU 301.

The display 306 displays various types of information, such as a cursor, a menu, a window, texts, and an image. The display 306 may be a touch panel display including an input unit. The external device connection I/F 307 is an interface for connecting various external devices. The external device in this case is, for example, a USB memory or a printer. The network I/F 308 is an interface for performing data communication using the communication network 1000. The bus line 309 is an address bus or date bus for electrically connecting the components of, for example, the CPU 301.

The keyboard 310 serves as an input device provided with multiple keys that allows, e.g., a user to input text (or characters), numerals, or various instructions. The pointing device 311 also serves as an input device that allows, e.g., a user to select or execute a specific instruction, select an object to be processed, or move a cursor. The input device is not limited to the keyboard 310 or the pointing device 311. For example, the input device may be a touch panel or an audio input device.

The DVD-RW drive 313 controls reading or writing of various types of data from or to a DVD-RW 312 as an example of a removable recording medium. The removable recording medium is not limited to the DVD-RW and may be a digital versatile disk recordable (DVD-R) or a Blu-Ray (registered trademark) disc (in the following description, the registered sign will be omitted), for example. The media I/F 315 controls the reading and writing (storing) of data from and to a recording media 314 such as a flash memory.

The hardware configuration of the server 500 is the same as the hardware configuration of the controller 300, and the reference numerals in the 300s in the above description are replaced with the reference numerals in the 500s. For this reason, the above-description will be omitted.

### Functional Configuration

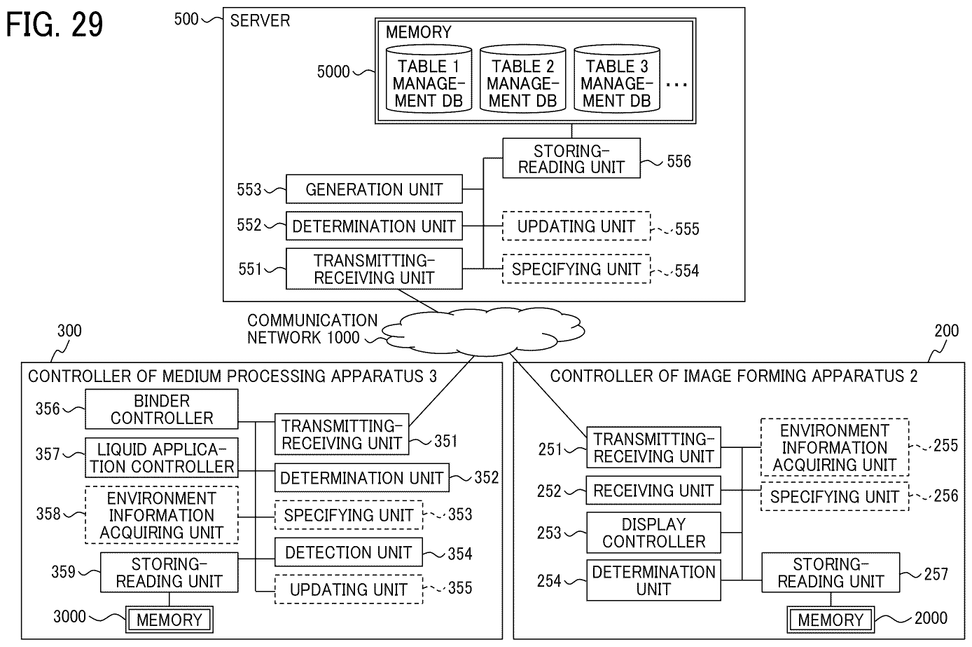

A description is given below of the functional configuration of the image forming system, with reference to FIG. 29.

FIG. 29 is a diagram illustrating an example of a functional configuration of the image forming system of FIG. 26.

FIG. 29 illustrates a functional configuration related to a process or operation of crimp binding.

### Functional Configuration of Medium Processing Device 3 (Controller 300)

A description is given of the functional configuration of the controller 300 that controls the processes or operations of the crimp binding in the medium processing apparatus 3.

The controller 300 includes a transmitting-receiving unit 351 as an information communicator, a determination unit 352, a specifying unit 353 as a specifying unit, a detection unit 354, an updating unit 355 as an updating unit, a binder controller 356, a liquid application controller 357 as a liquid application controller, an environment information acquiring unit 358, and a storing-reading unit 359. Each of the units described above is a function or a unit for functioning that is implemented by any of the components illustrated in FIG. 28 operating in response to an instruction from the CPU 301 in accordance with a program deployed on the RAM 303.

The controller 300 further includes a storage unit 3000 that is implemented by the ROM 302, the HD 304 or the recording media 314 illustrated in FIG. 28.

The transmitting-receiving unit 351 is implemented by the processing of the CPU 301 with respect to the network I/F 308. The transmitting-receiving unit 351 transmits and receives various data (or information) to and from another device or terminal such as the image forming apparatus 2 or an information processing apparatus (such as the server 500) via the communication network 1000.

The medium processing apparatus 3 and the image forming apparatus 2 may directly connect the transmitting-receiving unit 351 and a transmitting-receiving unit 251 and communicate with each other without the communication network 1000.

The determination unit 352 is mainly implemented by the processing of the CPU 301 and performs various determinations.

The specifying unit 353 is mainly implemented by the processing of the CPU 301. The specifying unit 353 specifies the liquid application amount based on the detection information from the moisture content detection sensor 43, the temperature-humidity information from the temperature and humidity sensor 210, and the past data related to the liquid application amount. The function of the specifying unit 353 does not have to be provided in the controller 300 of the medium processing apparatus 3, and may be provided as, for example, the specifying unit 256 in the controller 200 of the image forming apparatus 2. Alternatively, the specifying unit 554 may be provided in the server 500 as an information processing apparatus communicably connected via the communication network 1000.

The detection unit 354 is mainly implemented by the processing of the CPU 301 with respect to the moisture content detection sensor 43 of the stapleless stapler 5. The detection unit 354 detects the liquid application amount applied to the sheet P by the liquid application member 42.

The updating unit 355 is mainly implemented by the processing of the CPU 301. The updating unit 355 corrects, adds, and updates various data (information). The function of the updating unit 355 does not have to be provided in the controller 300 of the medium processing apparatus 3, and may be provided as, for example, the updating unit 555 in the server 500 as an information processing apparatus communicably connected via the communication network 1000.

The binder controller 356 is mainly implemented by the processing of the CPU 301 with respect to the binder 44 of the stapleless stapler 5. The binder controller 356 performs crimp binding on a sheet bundle including the sheet P to which liquid is applied. The liquid application controller 357 is mainly implemented by the processing of the CPU 301 with respect to the liquid application member 42 of the stapleless stapler 5. The liquid application controller 357 controls the pressing amount and the liquid application period of the liquid application member 42 on the sheet P based on the information of the liquid application amount specified by the specifying unit 353.

The environment information acquiring unit 358 is mainly implemented by the processing of the CPU 301 with respect to the temperature and humidity sensor 210. The environment information acquiring unit 358 acquires environmental information of the operating environment such as temperature and humidity at an operating location of the image forming system 1. The function of the environment information acquiring unit 358 does not have to be provided in the controller 300 of the medium processing apparatus 3, and may be provided as, for example, the environment information acquiring unit 255 in the controller 200 of the image forming apparatus 2 communicably connected via the communication network 1000.

The storing-reading unit 359 is mainly implemented by the processing of the CPU 301. The storing-reading unit 359 stores various data (or information) in the storage unit 3000 or reads various data (or information) from the storage unit 3000.

### Functional Configuration of Image Forming Apparatus 2 (Controller 200)

A description is given of the functional configuration of the controller 200 of the image forming apparatus 2.

Specifically, a description is given mainly of the part related to the control of the processing or operation of a crimp binding.

The controller 200 includes a transmitting-receiving unit 251 as an information communicator, a receiving unit 252, a display controller 253, a determination unit 254, an environment information acquiring unit 255, a specifying unit 256 as a specifying unit, and a storing-reading unit 257. Each of the units described above is a function or a unit for functioning that is implemented by any of the components illustrated in FIG. 27 operating in response to an instruction from the CPU 2001 in accordance with a program deployed on the RAM 2002b. The controller 200 further includes a storage unit 2000 that is implemented by the ROM 2002a or the HD 2008 illustrated in FIG. 27.

The transmitting-receiving unit 251 is mainly implemented by the processing of the CPU 2001 with respect to the network I/F 280. The transmitting-receiving unit 251 transmits and receives various data or information to and from another device or terminal such as the image forming apparatus 2 or an information processing apparatus (such as the server 500) via the communication network 1000. The image forming apparatus 2 and the medium processing apparatus 3 may directly connect the transmitting-receiving unit 251 and the transmitting-receiving unit 351 and communicate with each other without the communication network 1000.

The receiving unit 252 is mainly implemented by the processing of the CPU 2001 on the control panel 260, and receives various selections or inputs from the operators.

The display controller 253 is mainly implemented by the processing of the CPU 2001, and displays various screens on a display unit such as the control panel 260.

The determination unit 254 is mainly implemented by the processing of the CPU 2001 and performs various determinations.

The environment information acquiring unit 255 is mainly implemented by the processing of the CPU 2001 with respect to the temperature and humidity sensor 210. The environment information acquiring unit 255 acquires environmental information of the operating environment such as temperature and humidity at an operating location of the image forming system 1. The function of the environment information acquiring unit 255 does not have to be provided in the controller 200 of the image forming apparatus 2, and may be provided as, for example, the environment information acquiring unit 358 in the controller 300 of the medium processing apparatus 3 communicably connected via the communication network 1000.

The specifying unit 256 is mainly implemented by the processing of the CPU 301. The specifying unit 256 specifies the liquid application amount based on the detection information from the moisture content detection sensor 43 of the medium processing apparatus 3, the temperature-humidity information from the temperature and humidity sensor 210 of the image forming apparatus 2, and the past data related to the liquid application amount. The function of the specifying unit 256 does not have to be provided in the controller 200 of the image forming apparatus 2, and may be provided as, for example, the specifying unit 353 in the controller 300 of the medium processing apparatus 3. Alternatively, the specifying unit 554 may be provided in the server 500 as an information processing apparatus communicably connected via the communication network 1000.

The storing-reading unit 257 is implemented by the processing of the CPU 2001. The storing-reading unit 257 stores various data (or information) in the storage unit 2000 or reads various data (or information) from the storage unit 2000.

### Functional Configuration of Server 500

A description is given of a functional configuration of the server 500.

The server 500 includes a transmitting-receiving unit 551 as an information communicator, a determination unit 552, a generation unit 553, a specifying unit 554 as a specifying unit, an updating unit 555 as an updating unit, and a storing and reading unit 556. Each of the units described above is a function or a unit for functioning that is implemented by any of the components illustrated in FIG. 28 operating in response to an instruction from the CPU 501 in accordance with a server program deployed on the RAM 503. The server 500 further includes a storage unit 5000 that is implemented by the ROM 502, the HD 504, or the recording media 514 illustrated in FIG. 28.

The transmitting-receiving unit 551 is implemented by the processing of the CPU 501 with respect to the network I/F 508. The transmitting-receiving unit 551 transmits and receives various data or information to and from another device or terminal such as the image forming apparatus 2 or the medium processing apparatus 3 via the communication network 1000.

The determination unit 552 is implemented by the processing of the CPU 501 and performs various determinations.

The generation unit 553 is implemented by the processing of the CPU 501. The generation unit 553 causes the training data to be learned via machine learning and generates a trained model used when specifying the liquid application amount.

The specifying unit 554 is mainly implemented by the processing of the CPU 501. The specifying unit 554 specifies the liquid application amount based on, for example, the detection information from the moisture content detection sensor 43 of the medium processing apparatus 3, the temperature-humidity information from the temperature and humidity sensor 210 of the image forming apparatus 2, and the past data related to the liquid application amount. The function of the specifying unit 554 does not have to be provided in the server 500, and may be provided as, for example, the specifying unit 353 in the controller 300 of the medium processing apparatus 3. Alternatively, the specifying unit 554 may be provided as the specifying unit 256 in the controller 200 of the image forming apparatus 2.

The updating unit 555 is mainly implemented by the processing of the CPU 501. The updating unit 555 corrects, adds, and updates various data (information). The function of the updating unit 555 does not need to be provided in the server 500, and may be provided as the updating unit 355, for example, in the controller 300 of the medium processing apparatus 3.

The storing and reading unit 556 is implemented by the processing of the CPU 501. The storing and reading unit 556 stores various data (or information) in the storage unit 5000 or reads various data (or information) from the storage unit 5000. The storage unit 5000 of the server 500 includes managements DB including the above-described various tables (the first data table D1 to the fifteenth data table D15).

Each function of the embodiments described above can be implemented by one processing circuit or a plurality of processing circuits. In the embodiments of the present disclosure, the processing circuit includes a processor programmed to execute each of the functions by software such as a processor implemented by an electronic circuit, and a device such as an application-specific integrated circuit (ASIC), a digital signal processor (DSP), a field-programmable gate array (FPGA), or a circuit module designed to execute each function described above.

The present disclosure is not limited to the above-described embodiments, and numerous additional modifications and variations are possible in light of the teachings. The technical contents included in the technical ideas described in the appended claims are included within the scope of the present disclosure. The above-described embodiments represent examples, and various modifications can be achieved by those skilled in the art from the disclosed contents.

Such modifications are also included in the technical scope of the appended claims.

### Aspects of the Present Disclosure

Aspects of the present disclosure are, for example, as follows.

### Aspect 1

In Aspect 1, a medium processing apparatus includes a liquid applier, a liquid application amount detector, a specifying unit, a liquid application controller, and a crimp binder. The liquid applier applies liquid to at least one medium. The liquid application amount detector detects a liquid application amount of the liquid applied to the medium by the liquid applier. The specifying unit specifies the liquid application amount to be applied to the medium by the liquid applier based on detection information from the liquid application amount detector, environmental information of an operating environment, and past information of the liquid application amount. The liquid application controller applies the liquid based on information of the liquid application amount specified by the specifying unit.

The crimp binder performs a crimp binding operation on a media bundle including the medium to which the liquid is applied.

### Aspect 2

In Aspect 2, the medium processing apparatus according to Aspect 1 further includes an updating unit to specify the liquid application amount to be applied to the medium by the liquid applier, by using a trained model generated by machine learning based on training data in which environmental information of the operating environment and information of the liquid application amount are associated to each other, provide feedback on the information of the liquid application amount specified by the specifying unit and the detection result information detected by the liquid application amount detector, to the training data, and update the trained model.

### Aspect 3

In Aspect 3, in the medium processing apparatus according to Aspect 1 or Aspect 2, when the past information and the detection result information have a deviation that occurs in a certain interval, the liquid application amount by the liquid applier is corrected.

### Aspect 4

In Aspect 4, in the medium processing apparatus according to Aspect 1 or Aspect 2, when the past information and the detection information used to specify the liquid application amount have a deviation that sequentially occurs in a certain interval, the liquid application amount is corrected by the liquid applier based on a result of a last medium of a single media bundle.

### Aspect 5

In Aspect 5, in the medium processing apparatus according to any one of Aspects 1 to 4, information of a number of media of the media bundle is included to specify the liquid application amount by the specifying unit.

### Aspect 6

In Aspect 6, in the medium processing apparatus according to any one of Aspects 1 to 4, information of a sheet type of the medium is included to specify the liquid application amount by the specifying unit.

### Aspect 7

In Aspect 7, in the medium processing apparatus according to any one of Aspects 1 to 4, information of a sheet thickness of the medium is included to specify the liquid application amount by the specifying unit.

### Aspect 8

In Aspect 8, in the medium processing apparatus according to any one of Aspects 1 to 4, information of a liquid type of the liquid is included to specify the liquid application amount by the specifying unit.

### Aspect 9

In Aspect 9, in the medium processing apparatus according to any one of Aspects 1 to 4, information of a fixing temperature of an image forming apparatus, which is coupled to the medium processing apparatus and is disposed upstream from the medium processing apparatus in a sheet conveyance direction, is included to specify the liquid application amount by the specifying unit.

### Aspect 10

In Aspect 10, in the medium processing apparatus according to any one of Aspects 1to 4, at least two of information of a number of media of the media bundle, information of a sheet type of the medium, information of a sheet thickness of the medium, information of a liquid type of the liquid, or information of a fixing temperature of an image forming apparatus, which is coupled to the medium processing apparatus and is disposed upstream from the medium processing apparatus in a sheet conveyance direction, are included to specify the liquid application amount by the specifying unit.

### Aspect 11

In Aspect 11, an image forming system includes an image forming apparatus to form an image on a medium of a media bundle, and a medium processing apparatus to perform a process on the medium. The image forming apparatus includes a specifying unit to specify the liquid application amount based on environmental information of an operating environment and past information of the liquid application amount. The medium processing apparatus includes a liquid applier, a liquid application amount detector, a liquid application controller, and a crimp binder. The liquid applier applies liquid to at least one medium. The liquid application amount detector detects a liquid application amount of the liquid applied to the medium by the liquid applier. The liquid application controller controls liquid application by the liquid applier based on detection result information detected by the liquid application amount detector, and information of the liquid application amount detected by the specifying unit. The crimp binder performs a crimp binding operation on the media bundle including the medium to which the liquid is applied.

### Aspect 12

In Aspect 12, an image forming system includes an image forming apparatus to form an image on a medium of a media bundle, a medium processing apparatus to perform a process on the medium, and an information processing apparatus communicable with at least the image forming apparatus. The information processing apparatus includes a specifying unit to specify the liquid application amount based on environmental information of an operating environment and past information of the liquid application amount. The image forming apparatus includes an information communicator to transmit at least the environmental information to the information processing apparatus, and receive information of the liquid application amount specified by the information processing apparatus. The medium processing apparatus includes a liquid applier, a liquid application amount detector, a liquid application controller, and a crimp binder. The liquid applier applies liquid to at least one medium. The liquid application amount detector detects a liquid application amount of the liquid applied to the medium by the liquid applier. The liquid application controller controls liquid application by the liquid applier based on detection result information detected by the liquid application amount detector and information of the liquid application amount received by the information communicator of the image forming apparatus. The crimp binder performs a crimp binding operation on the media bundle including the medium to which the liquid is applied.

### Aspect 13

In Aspect 13, an image forming system includes an image forming apparatus to form an image on a medium of a media bundle, a medium processing apparatus to perform a process on the medium, and an information processing apparatus communicable with at least the image forming apparatus. The information processing apparatus includes a specifying unit to specify the liquid application amount based on environmental information of an operating environment and past information of the liquid application amount. The medium processing apparatus includes a liquid applier, a liquid application amount detector, an information communicator, a liquid application controller, and a crimp binder. The liquid applier applies liquid to at least one medium. The liquid application amount detector detects a liquid application amount of the liquid applied to the medium by the liquid applier. The information communicator transmits at least the environmental information to the information processing apparatus, and receives information of the liquid application amount specified by the information processing apparatus. The liquid application controller controls liquid application by the liquid applier based on detection result information detected by the liquid application amount detector and information of the liquid application amount received by the information communicator. The crimp binder performs a crimp binding operation on the media bundle including the medium to which the liquid is applied.

According to Aspect 1, the binding force of the media bundle can be appropriately obtained.

According to Aspect 2, a liquid application amount with high accuracy can be determined based on a past trained model by using machine learning. In addition, by feeding back to the training data, the optimum liquid application according to the operating environment of the customer can be provided.

According to Aspect 3, the optimum liquid application can be provided in consideration of, for example, a mechanical error and a degree of wear of the liquid application member. In addition, by performing appropriate liquid application, the binding force can be obtained.

According to Aspect 4, the changes of the sheet type, the sheet thickness, the sheet lots, and the storage environment are noticed, and an appropriate liquid application amount can be provided on and after the subsequent crimp binding operation.

According to Aspect 5, by adding the sheet number of the sheet information when generating the trained data, appropriate liquid application can be performed in consideration of external factors such as the fixing temperature of the housing of the medium processing apparatus.

According to Aspect 6, by adding the sheet type when generating the trained data, appropriate liquid application can be performed in consideration of the water absorbency of each sheet.

According to Aspect 7, by adding the sheet thickness when generating the trained data, appropriate liquid application can be performed in consideration of the water absorbency of each sheet thickness.

According to Aspect 8, by adding the liquid (water) type (e.g., hardness) when generating the trained data, appropriate liquid application can be performed in consideration of the water absorbency of each sheet.

According to Aspect 9, by adding the fixing temperature when generating the trained data, appropriate liquid application can be performed in consideration of evaporation of the liquid applied to the sheet.

According to Aspect 10, by considering the relation of multiple datasets in combination of the datasets, appropriate liquid application can be performed.

According to Aspects 11 to 13, an image forming system that can appropriately obtain the binding force of a media bundle (sheet bundle).

### Aspect 14 (1)

In Aspect 14, a medium processing apparatus includes a liquid applier, a liquid detector, circuitry, and a crimp binder. The liquid applier applies liquid to a media bundle including a medium. The liquid detector detects a liquid application amount of the liquid applied to the medium by the liquid applier. The circuitry is to specify the liquid application amount to be applied to the medium by the liquid applier based on amount information including the liquid application amount detected by the liquid detector, environmental information of an operating environment of the liquid detector, and past information of the liquid application amount, and cause the liquid applier to apply the liquid to the media bundle based on the liquid application amount specified. The crimp binder crimps and binds the media bundle applied with the liquid to perform a crimp binding operation.

### Aspect 15 (2)

In Aspect 15, in the medium processing apparatus according to Aspect 14, the circuitry is further to generate a trained model by machine learning based on training data in which the environment information and the amount information are associated to each other, use the trained model to specify the liquid application amount, feedback, to the training data, the liquid application amount specified, and the amount information detected by the liquid detector, to update the trained model.

### Aspect 16 (3)

In Aspect 16, in the medium processing apparatus according to Aspect 14 or Aspect 15, the circuitry is further to correct the liquid application amount, when the amount information deviates from the past information in each of multiple media bundles including the media bundle.

### Aspect 17 (4)

In Aspect 17, in the medium processing apparatus according to Aspect 14 or Aspect 15, the circuitry is further to correct the liquid application amount, based on the liquid application amount of a last medium in a single media bundle including two or more media including the medium, when the amount information sequentially deviates from the past information in the two or more media.

### Aspect 18 (5)

In Aspect 18, in the medium processing apparatus according to any one of Aspects 14 to 17, the circuitry is further to refer to information of a number of media of the media bundle to specify the liquid application amount.

### Aspect 19 (6)

In Aspect 19, in the medium processing apparatus according to any one of Aspects 14 to 17, the circuitry is further to refer to information of a sheet type of the medium to specify the liquid application amount.

### Aspect 20 (7)

In Aspect 20, in the medium processing apparatus according to any one of Aspects 14 to 17, the circuitry is further to refer to information of a sheet thickness of the medium to specify the liquid application amount.

### Aspect 21 (8)

In Aspect 21, in the medium processing apparatus according to any one of Aspects 14 to 17, the circuitry is further to refer to information of a liquid type of the liquid to specify the liquid application amount.

### Aspect 22 (9)

In Aspect 22, in the medium processing apparatus according to any one of Aspects 14 to 17, the circuitry is further to refer to information of a fixing temperature of an image forming apparatus to specify the liquid application amount, where the image forming apparatus is coupled to the medium processing apparatus at an upstream position in a sheet conveyance direction.

### Aspect 23 (10)

In Aspect 23, in the medium processing apparatus according to any one of Aspects 14 to 17, the circuitry is further to refer to at least two of information of a number of media, information of a sheet type of the medium, information of a sheet thickness of the medium, information of a liquid type of the liquid, or information of a fixing temperature of an image forming apparatus, to specify the liquid application amount. The image forming apparatus is coupled to the medium processing apparatus at an upstream position in a sheet conveyance direction.

### Aspect 24 (11)

In Aspect 24, an image forming system including an image forming apparatus, and a medium processing apparatus. The image forming apparatus forms an image on a medium of a media bundle. The image forming apparatus includes circuitry to specify a liquid application amount based on environmental information of an operating environment, and past information of the liquid application amount. The medium processing apparatus performs a process on the medium. The medium processing apparatus includes a liquid applier, a liquid detector, circuitry, and a crimp binder. The liquid applier applies liquid to the media bundle including the medium. The liquid detector detects a liquid application amount of the liquid applied to the medium by the liquid applier. The circuitry is to cause the liquid applier to apply the liquid to the media bundle based on amount information detected by the liquid detector and the liquid application amount specified. The crimp binder crimps and binds the media bundle applied with the liquid to perform a crimp binding operation.

### Aspect 25 (12)

In Aspect 25, an image forming system including an information processing apparatus, an image forming apparatus, and a medium processing apparatus. The information processing apparatus specified a liquid application amount based on environmental information of an operating environment, and past information of the liquid application amount. The image forming apparatus is communicable with the information processing apparatus to form an image on a medium of a media bundle. The image forming apparatus includes an information communicator to transmit the environmental information to the information processing apparatus, and receive information of the liquid application amount specified by the information processing apparatus. The medium processing apparatus performs a process on the medium. The medium processing apparatus includes a liquid applier, a liquid detector, circuitry, and a crimp binder. The liquid applier applies liquid to the media bundle including the medium. The liquid detector detects a liquid application amount of the liquid applied to the medium by the liquid applier. The circuitry is to cause the liquid applier to apply the liquid to the media bundle based on amount information detected by the liquid detector, and the liquid application amount received via the information communicator of the image forming apparatus. The crimp binder crimps and binds the media bundle applied with the liquid to perform a crimp binding operation.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a liquid applier to apply liquid to a media bundle including a medium;
a liquid detector to detect a liquid application amount of the liquid applied to the medium by the liquid applier;
circuitry configured to:
specify the liquid application amount to be applied to the medium by the liquid applier based on:
amount information including the liquid application amount detected by the liquid detector;
environmental information of an operating environment of the liquid detector; and
past information of the liquid application amount; and
cause the liquid applier to apply the liquid to the media bundle based on the liquid application amount specified; and
a crimp binder to crimp and bind the media bundle applied with the liquid to perform a crimp binding operation.

2. The medium processing apparatus according to claim 1,
wherein the circuitry is further configured to:
generate a trained model by machine learning based on training data in which:
the environment information; and
the amount information,
are associated to each other,
use the trained model to specify the liquid application amount;
feedback, to the training data,
the liquid application amount specified; and
the amount information detected by the liquid detector,
to update the trained model.

3. The medium processing apparatus according to claim 1,
wherein the circuitry is further configured to:
correct the liquid application amount,
when the amount information deviates from the past information in each of multiple media bundles including the media bundle.

4. The medium processing apparatus according to claim 1,
wherein the circuitry is further configured to:
correct the liquid application amount,
based on the liquid application amount of a last medium in a single media bundle including two or more media including the medium,
when the amount information sequentially deviates from the past information in the two or more media.

5. The medium processing apparatus according to claim 1,
wherein the circuitry is further configured to refer to information of a number of media of the media bundle to specify the liquid application amount.

6. The medium processing apparatus according to claim 1,
wherein the circuitry is further configured to refer to information of a sheet type of the medium to specify the liquid application amount.

7. The medium processing apparatus according to claim 1,
wherein the circuitry is further configured to refer to information of a sheet thickness of the medium to specify the liquid application amount.

8. The medium processing apparatus according to claim 1,
wherein the circuitry is further configured to refer to information of a liquid type of the liquid to specify the liquid application amount.

9. The medium processing apparatus according to claim 1,
wherein the circuitry is further configured to refer to information of a fixing temperature of an image forming apparatus to specify the liquid application amount,
where the image forming apparatus is coupled to the medium processing apparatus at an upstream position in a sheet conveyance direction.

10. The medium processing apparatus according to claim 1,
wherein the circuitry is further configured to refer to at least two of:
information of a number of media;
information of a sheet type of the medium;
information of a sheet thickness of the medium;
information of a liquid type of the liquid; or
information of a fixing temperature of an image forming apparatus,
to specify the liquid application amount, and
the image forming apparatus is coupled to the medium processing apparatus at an upstream position in a sheet conveyance direction.

11. An image forming system comprising:
an image forming apparatus to form an image on a medium of a media bundle,
the image forming apparatus including:
circuitry configured to:
specify a liquid application amount based on:
environmental information of an operating environment; and
past information of the liquid application amount; and
a medium processing apparatus to perform a process on the medium,
the medium processing apparatus including:
a liquid applier to apply liquid to the media bundle including the medium;
a liquid detector to detect a liquid application amount of the liquid applied to the medium by the liquid applier;
circuitry configured to cause the liquid applier to apply the liquid to the media bundle based on:
amount information detected by the liquid detector; and
the liquid application amount specified; and
a crimp binder to crimp and bind the media bundle applied with the liquid to perform a crimp binding operation.

12. An image forming system comprising:
an information processing apparatus to specify a liquid application amount based on:
environmental information of an operating environment; and
past information of the liquid application amount; and
an image forming apparatus communicable with the information processing apparatus to form an image on a medium of a media bundle,
the image forming apparatus including:
an information communicator configured to:
transmit the environmental information to the information processing apparatus; and
receive information of the liquid application amount specified by the information processing apparatus; and
a medium processing apparatus to perform a process on the medium,
the medium processing apparatus including:
a liquid applier to apply liquid to the media bundle including the medium;
a liquid detector to detect a liquid application amount of the liquid applied to the medium by the liquid applier;
circuitry configured to cause the liquid applier to apply the liquid to the media bundle based on:
amount information detected by the liquid detector; and
the liquid application amount received via the information communicator of the image forming apparatus; and
a crimp binder to crimp and bind the media bundle applied with the liquid to perform a crimp binding operation.
